(19) United States
(12) Patent Application Publication
(10) Pub. No.: US 2025/0108817 A1
(43) Pub. Date: Apr. 3, 2025

(54) AUTONOMOUS VEHICLES

(71) Applicant: Wayve Technologies Limited, London (GB)

(72) Inventors: Alex Guy Kendall, London (GB); Anthony Hu, London (GB); Elahe Arani, Eindhoven (NL); Georgii Fedoseev, London (GB); Gianluca Corrado, London (GB); Hudson Yeo Chuan En, London (GB); Jamie Daniel Joseph Shotton, Cambridge (GB); Lloyd Edward Russell, London (GB); Remi Tachet des Combes, London (GB); Zachary Paul Murez, Berkeley, CA (US)

(21) Appl. No.: 18/585,609

(22) Filed: Feb. 23, 2024

(30) Foreign Application Priority Data
Sep. 28, 2023 (GB) 2314928.9
Nov. 6, 2023 (GB) 2317029.3

(51) Int. Cl. B60W 50/06; B60W 60/00; G06N 3/0455; G06N 3/098; G06V 10/766; G06V 10/774; G06V 10/82; G06V 20/56

(52) U.S. Cl. CPC B60W 50/06; B60W 60/00; G06N 3/0455; G06N 3/098; G06V 10/766; G06V 10/774; G06V 20/56; B60W 2420/403; G06V 10/82

(57) ABSTRACT

An autonomous driving system comprising: an image encoder configured to receive video input data, said video input data comprising a plurality of time-varying image frames, wherein the image encoder is further configured to encode the image frames as a sequence of input tokens; a pre-trained world model having a set of pre-trained world model weights, the world model being configured to receive the sequence of input tokens and to generate therefrom a world state based on said sequence, wherein the world state comprises an implicit representation of candidate future events; a driving decoder configured to receive the world state from the world model and to generate in a single forward pass a driving plan based on the implicit representation of candidate future events.

### CROSS-REFERENCE TO RELATED APPLICATIONS

This application claims priority to United Kingdom Patent Application No. 2314928.9 filed on Sep. 28, 2023 and to United Kingdom Patent Application No. 2317029.3 filed on Nov. 6, 2023, wherein the entire contents of the foregoing applications are hereby incorporated by reference herein.

### TECHNICAL FIELD

This invention relates to autonomous vehicles, such as autonomous cars, trucks, buses, vans, and such like. Particularly, though not exclusively, the present invention is concerned with improving decision making for ‘end-to-end’ methods of autonomous driving.

### BACKGROUND ART

There has been a great deal of development in recent years in the field of autonomous vehicles, with ever more advanced self-driving vehicles becoming a reality. There are varying degrees of autonomy, often referred to as the ‘levels’ of automation, with these levels progressively outsourcing more of the driving functions from a human operator to a computer or ‘automated driver system’ (ADS). Much advancement has been made in recent years towards truly autonomous vehicles which can drive in a real-world road environment without any human interaction.

There are a number of different approaches to autonomous driving, with different paradigms being used. Some current autonomous driving systems, known in the art per se, make use of a modular paradigm in which a series of discrete processing stages make driving decisions based on predetermined rules. These modules may make utilize sensor fusion methods and route-locating algorithms, emphasizing environmental perception. However, these systems often struggle with complex situations, and their interpretation and response capabilities can be limited. Furthermore, such modular systems can suffer from error propagation.

Other solutions make use of ‘end-to-end’ methods, and there has been large progress in end-to-end deep learning methods for autonomous systems in recent years. Those skilled in the art will appreciate that with an ‘end-to-end’ paradigm, inputs from the car's sensors are typically mapped directly to driving outputs. This approach may provide better performance with complex or unusual situations. End-to-end approaches may also be more reliable compared to modular approaches which can suffer from error propagation.

However, the Applicant has appreciated that a major challenge with modern autonomous driving systems is performance, particularly with respect to the speed of the decision-making process. In autonomous vehicle applications, it is critical that decisions can be made and acted upon swiftly and safely, in an environment in which the surrounding world can change quickly and in potentially unexpected ways. In order to plan what actions the vehicle should take, typically a number of possible future events are considered and planned for, before a decision is taken and acted upon.

Typical fully learned systems, known in the art perse, are too slow to deploy in a real-world vehicle because they require interleaving planning and rolling out future world dynamics. Such a system may typically require several seconds (at least) in order to make a decision. This performance is simply too slow to be usable in a practical system, in which a decision should be made within approximately 100 ms.

If the model is too slow, the autonomous vehicle would be making a decision too late for it to be relevant. By way of example, in general when a model makes a decision in the car it may need to output the next 2 to 5 seconds worth of actions (which can be anything between 10 and 50 instantaneous actions, e.g. if you want to stop in the next 5 s and your speed is 10 mph, you would expect to be at e.g. 8 mph in 1 s, 6 mph in 2 s until reaching 0 mph in 5 s). These 2 to 5 seconds are typically not fully executed because another decision will be made shortly after (after say 50 to 100 ms). Nevertheless in order to plan the next 2 to 5 s, the model needs to somehow anticipate what is going to happen next and plan its trajectory accordingly.

The Applicant has previously developed GAIA-1 (Generative Artificial Intelligence for Autonomy), which utilises a multi-modal approach that leverages video, text and action inputs to generate realistic driving videos. By training on a vast corpus of real-world UK urban driving data, the GAIA-1 model learns to predict the subsequent frames in a video sequence, resulting in an autoregressive (AR) prediction capability without needing any labels. This resembles the approach seen in large language models (LLMs).

GAIA-1 is a true world model that learns to understand and disentangle the important concepts of driving, including cars, trucks, buses, pedestrians, cyclists, road layouts, buildings, and traffic lights. What sets the GAIA-1 model apart from other models, known in the art per se, is its ability to provide fine-grained control over both ego-vehicle (i.e. the autonomous vehicle itself) behaviour and other essential scene features. Whether altering the ego-vehicle's behaviour or modifying the overall scene dynamics, this model offers unparalleled flexibility, making it an invaluable tool for accelerating the development of foundation models for autonomous driving.

The Applicant has appreciated the need for further developments to autonomous vehicles to improve performance such that learned models may be used in a practical, real time driving environment.

### SUMMARY OF THE INVENTION

In accordance with a first aspect, embodiments of the present invention provide an autonomous driving system comprising:
an image encoder configured to receive video input data, said video input data comprising a plurality of time-varying image frames, wherein the image encoder is further configured to encode the image frames as a sequence of input tokens;
a pre-trained world model having a set of pre-trained world model weights, the world model being configured to receive the sequence of input tokens and to generate therefrom a world state based on said sequence, wherein the world state comprises an implicit representation of candidate future events;
a driving decoder configured to receive the world state from the world model and to generate in a single forward pass a driving plan based on the implicit representation of candidate future events.

The first aspect of the invention extends to a method of operating an autonomous driving system, the method comprising:
i) receiving video input data, said video input data comprising a plurality of time-varying image frames;
ii) encoding the image frames as a sequence of input tokens;
iii) inputting the sequence of input tokens into a pre-trained world model having a set of pre-trained world model weights;
iv) using the pre-trained world model to generate a world state based on said sequence, wherein the world state comprises an implicit representation of candidate future events;
v) in a single forward pass, generating from the world state a driving plan based on the implicit representation of candidate future events.

The first aspect of the invention also extends to a non-transitory computer-readable medium comprising instructions which, when executed by a processor, cause the processor to carry out a method of operating an autonomous driving system, the method comprising:
i) receiving video input data, said video input data comprising a plurality of time-varying image frames;
ii) encoding the image frames as a sequence of input tokens;
iii) inputting the sequence of input tokens into a pre-trained world model having a set of pre-trained world model weights;
iv) using the pre-trained world model to generate a world state based on said sequence, wherein the world state comprises an implicit representation of candidate future events;
v) in a single forward pass, generating from the world state a driving plan based on the implicit representation of candidate future events.

The first aspect of the invention further extends to a computer software product comprising instructions which, when executed by a processor, cause the processor to carry out a method of operating an autonomous driving system, the method comprising:
i) receiving video input data, said video input data comprising a plurality of time-varying image frames;
ii) encoding the image frames as a sequence of input tokens;
iii) inputting the sequence of input tokens into a pre-trained world model having a set of pre-trained world model weights;
iv) using the pre-trained world model to generate a world state based on said sequence, wherein the world state comprises an implicit representation of candidate future events;
v) in a single forward pass, generating from the world state a driving plan based on the implicit representation of candidate future events.

When viewed from a second aspect, embodiments of the present invention provide a method of training an autonomous driving system, the method comprising:
a) training a world model to generate a world state from video input data, wherein the world state comprises an implicit representation of candidate future events, the step of training the world model comprising:
   i) receiving video training data, said video training data comprising a plurality of time-varying image frames;
   ii) encoding the image frames to generate image encodings;
   iii) generating a sequence of input tokens from the image encodings; and
   iv) using an autoregressive transformer to model the sequence, thereby generating a trained world model having a set of learned world model weights; and
b) training a machine learning driving decoder to generate driving plans based on world states received from the world model, the step of training the driving decoder comprising:
   i) initialising a set of driving decoder weights;
   ii) receiving further video training data, said further video training data comprising a plurality of time-varying further image frames;
   iii) encoding the further image frames to generate further image encodings;
   iv) generating a sequence of further input tokens from the further image encodings;
   v) inputting the further image encodings to the trained world model, and using the trained world model to generate a world state from said further image encodings;
   vi) inputting the world state to the driving decoder, and using the driving decoder to generate a new driving plan based on the world state and a current set of driving decoder weights;
   vii) updating the set of driving decoder weights based on a difference between the new driving plan and a driving plan prior corresponding to the further video training data.

The second aspect of the invention also extends to a non-transitory computer-readable medium comprising instructions which, when executed by a processor, cause the processor to carry out a method of training an autonomous driving system, the method comprising:
a) training a world model to generate a world state from video input data, wherein the world state comprises an implicit representation of candidate future events, the step of training the world model comprising:
   i) receiving video training data, said video training data comprising a plurality of time-varying image frames;
   ii) encoding the image frames to generate image encodings;
   iii) generating a sequence of input tokens from the image encodings; and
   iv) using an autoregressive transformer to model the sequence, thereby generating a trained world model having a set of learned world model weights; and
b) training a machine learning driving decoder to generate driving plans based on world states received from the world model, the step of training the driving decoder comprising:
   i) initialising a set of driving decoder weights;
   ii) receiving further video training data, said further video training data comprising a plurality of time-varying further image frames;
   iii) encoding the further image frames to generate further image encodings;
   iv) generating a sequence of further input tokens from the further image encodings;
   v) inputting the further image encodings to the trained world model, and using the trained world model to generate a world state from said further image encodings;
   vi) inputting the world state to the driving decoder, and using the driving decoder to generate a new driving plan based on the world state and a current set of driving decoder weights;
   vii) updating the set of driving decoder weights based on a difference between the new driving plan and a driving plan prior corresponding to the further video training data.

The second aspect of the invention further extends to a computer software product comprising instructions which, when executed by a processor, cause the processor to carry out a method of training an autonomous driving system, the method comprising:
a) training a world model to generate a world state from video input data, wherein the world state comprises an implicit representation of candidate future events, the step of training the world model comprising:
   i) receiving video training data, said video training data comprising a plurality of time-varying image frames;
   ii) encoding the image frames to generate image encodings;
   iii) generating a sequence of input tokens from the image encodings; and
   iv) using an autoregressive transformer to model the sequence, thereby generating a trained world model having a set of learned world model weights; and
b) training a machine learning driving decoder to generate driving plans based on world states received from the world model, the step of training the driving decoder comprising:
   i) initialising a set of driving decoder weights;
   ii) receiving further video training data, said further video training data comprising a plurality of time-varying further image frames;
   iii) encoding the further image frames to generate further image encodings;
   iv) generating a sequence of further input tokens from the further image encodings;
   v) inputting the further image encodings to the trained world model, and using the trained world model to generate a world state from said further image encodings;
   vi) inputting the world state to the driving decoder, and using the driving decoder to generate a new driving plan based on the world state and a current set of driving decoder weights;
   vii) updating the set of driving decoder weights based on a difference between the new driving plan and a driving plan prior corresponding to the further video training data.

When viewed from a third aspect, embodiments of the present invention provide a method of training a machine learning driving decoder, the method comprising:
i) receiving a pre-trained world model having a set of learned world model weights;
ii) initialising a set of driving decoder weights;
iii) receiving video training data, said video training data comprising a plurality of time-varying further image frames;
iv) encoding the image frames to generate image encodings;
v) generating a sequence of input tokens from the image encodings;
vi) inputting the image encodings to the pre-trained world model, and using the pre-trained world model to generate a world state from said image encodings;
vi) inputting the world state to the driving decoder, and using the driving decoder to generate a new driving plan based on the world state and a current set of driving decoder weights;
vii) updating the set of driving decoder weights based on a difference between the new driving plan and a driving plan prior corresponding to the video training data.

The third aspect of the invention also extends to a non-transitory computer-readable medium comprising instructions which, when executed by a processor, cause the processor to carry out a method of training a machine learning driving decoder, the method comprising:
i) receiving a pre-trained world model having a set of learned world model weights;
ii) initialising a set of driving decoder weights;
iii) receiving video training data, said video training data comprising a plurality of time-varying further image frames;
iv) encoding the image frames to generate image encodings;
v) generating a sequence of input tokens from the image encodings;
vi) inputting the image encodings to the pre-trained world model, and using the pre-trained world model to generate a world state from said image encodings;
vi) inputting the world state to the driving decoder, and using the driving decoder to generate a new driving plan based on the world state and a current set of driving decoder weights;
vii) updating the set of driving decoder weights based on a difference between the new driving plan and a driving plan prior corresponding to the video training data.

The third aspect of the invention further extends to a computer software product comprising instructions which, when executed by a processor, cause the processor to carry out a method of training a machine learning driving decoder, the method comprising:
i) receiving a pre-trained world model having a set of learned world model weights;
ii) initialising a set of driving decoder weights;
iii) receiving video training data, said video training data comprising a plurality of time-varying further image frames;
iv) encoding the image frames to generate image encodings;
v) generating a sequence of input tokens from the image encodings;
vi) inputting the image encodings to the pre-trained world model, and using the pre-trained world model to generate a world state from said image encodings;
vi) inputting the world state to the driving decoder, and using the driving decoder to generate a new driving plan based on the world state and a current set of driving decoder weights;
vii) updating the set of driving decoder weights based on a difference between the new driving plan and a driving plan prior corresponding to the video training data.

Thus it will be appreciated that embodiments of the present invention provide an advantageous arrangement which provides for enhanced model performance by training and deploying driving models that leverage world models. The model may be fine-tuned for driving tasks and subsequently applied within a vehicle for real-time decision-making.

The Applicant has appreciated that the type of world model that may otherwise be used for generative prediction (such as the Applicant's GAIA-1 model) already captures information about possible futures. This is because the world model is a neural network designed to acquire an implicit state, encompassing the current state of the world and its potential future evolutions. Embodiments of the present invention leverage this insight—rather than needing to iteratively roll out a future scene, plan a driving action, and then roll out the resultant driving scene (and so on), the existing ‘multiple possible futures’ implicitly represented in the world state can be used.

Thus, with the approach of the present invention, this implicit state provided by the pre-trained world model can serve as a latent state for a model responsible for controlling the autonomous vehicle—the Applicant refers to this driving model as GAIA-Drive. Initially, the network learns this implicit state through future prediction tasks involving video (and potentially text data, action data, and/or auxiliary sensor data, as outlined below). The implicit representation is trained to automatically anticipate future events within the operating environment of an autonomous vehicle, eliminating the necessity for explicit specification or undertaking explicit rollouts to estimate potential futures.

By avoiding the need to roll out multiple different futures and with iterative planning, embodiments of the present invention allow a driving plan to be generated much faster than is possible with conventional approaches, known in the art per se. This may advantageously allow processing to occur sufficiently quickly that the learned model can be deployed in a real-world autonomous vehicle, with it being able to make decisions quickly enough to be used safely and reliably.

As outlined above, the driving plan is generated in a single forward pass operation. This means that the decoding process occurs in a singular forward pass, deliberately excluding any backward loops into the world model. This modification eliminates the need for the model to predict future events (removing the need to loop back into the world model, i.e. avoiding autoregressive prediction), streamlining the pathway directly to the driving decoder for immediate decision-making without future-oriented information generation. This novel approach enhances the efficiency and real-time applicability of the model within the context of driving scenarios. Compared to other learnable systems known in the art per se, embodiments of the present invention may advantageously allow efficient computation of a state of the world that captures the expectations of the future dynamics in one forward pass. This may effectively allow the model to be deployed to real world applications such as in an autonomous vehicle.

Once deployed in an autonomous vehicle, images are captured, encoded, and fed into the pre-trained world model. In some embodiments, one or more cameras are configured to capture the video input data and to provide said video input data to the image encoder.

The term ‘pre-trained’ is used herein because from the perspective of the model that is used for the generation of driving plans, the world model is already trained. It should be noted, however, that in some embodiments of certain aspects the invention, the training of that world model may form part of the invention. In some embodiments, the pre-trained world model is trained by:
i) receiving video training data, said video training data comprising a plurality of time-varying image frames;
ii) encoding the image frames to generate image encodings;
iii) generating a sequence of input tokens from the image encodings; and
iv) using an autoregressive transformer to model the sequence, thereby generating the pre-trained world model and the set of learned world model weights.

When training the model for driving, the existing parameters of a pre-trained world model are employed as a foundation. The parameters of the driving decoder, a new component, are initialised, e.g. at random. This configuration allows the model to process video inputs (e.g. from the car's cameras) and does not require input of e.g. textual or action data.

The driving model leverages the knowledge of the pre-trained world model to process image features, creating comprehensive world modelling features. These features may, in some embodiments, be augmented with additional pertinent driving data such as information from a route map indicating the desired trajectory.

The fusion of world modelling features and relevant driving data undergoes decoding through the driving decoder, generating a driving plan. This driving plan could encompass various components, such as waypoints, speed adjustments, curvature, and driving indicators.

Embodiments of the present invention may provide various further improvements over explicit world state estimators for autonomous driving.

The invention provides a data-driven approach in which the model can learn to estimate world states and predict their evolution from real-world data. As a result, the invention may provide for more accurate modelling of complex real-world driving scenarios.

Additionally, the invention may provide improvements in adaptability and generalisation as the model can adapt to new scenarios and generalise to previously unseen situations. Assuming the model learns from a sufficiently large dataset, it can capture variations and edge cases, making it more robust and better equipped to handle novel situations.

Furthermore, the invention may exhibit a reduction in bias because the model learns from data, reducing the need for manual design and minimising the potential for human-induced biases. This leads to more objective and unbiased training and validation data.

In some embodiments, the driving plan comprises one or more of: a waypoint, a speed, a velocity, a curvature, a trajectory, an indicator signal, an acceleration value, a braking value, a parking brake value, a steering angle, a lighting setting, and a horn setting. It will be appreciated that the driving plan may include any or all of these. The driving plan may, additionally or alternatively, include any other suitable operational variable of the autonomous vehicle.

As mentioned previously, the input to the driving decoder may be augmented with additional driving data, e.g. a route map indicating the desired trajectory. Thus in some embodiments, the driving decoder is further configured to receive a route plan input, wherein the driving decoder is further configured to generate the driving plan based on the route plan input. Thus, in certain embodiments, the method further comprises: i) receiving a route plan input; and ii) generating the driving plan based on the route plan input. The route plan may, in some such embodiments, comprise data representative of a route and/or a destination.

The driving decoder may itself be a trainable component. In some embodiments, the driving decoder is trained by:
i) initialising a set of driving decoder weights;
ii) receiving further video training data, said further video training data comprising a plurality of time-varying further image frames;
iii) encoding the further image frames to generate further image encodings;
iv) generating a sequence of further input tokens from the further image encodings;
v) inputting the further image encodings to the trained world model, and using the trained world model to generate a world state from said further image encodings;
vi) inputting the world state to the driving decoder, and using the driving decoder to generate a new driving plan based on the world state and a current set of driving decoder weights;
vii) updating the set of driving decoder weights based on a difference between the new driving plan and a driving plan prior corresponding to the further video training data.

Thus, in some embodiments, the method further comprises:
i) initialising a set of driving decoder weights;
ii) receiving further video training data, said further video training data comprising a plurality of time-varying further image frames;
iii) encoding the further image frames to generate further image encodings;
iv) generating a sequence of further input tokens from the further image encodings;
v) inputting the further image encodings to the trained world model, and using the trained world model to generate a world state from said further image encodings;
vi) inputting the world state to the driving decoder, and using the driving decoder to generate a new driving plan based on the world state and a current set of driving decoder weights;
vii) updating the set of driving decoder weights based on a difference between the new driving plan and a driving plan prior corresponding to the further video training data;
   wherein the set of driving decoder weights are used in the step of generating from the world state a driving plan based on the implicit representation of candidate future events.

The driving decoder weights could be initialised to a predetermined set of values. In some embodiments, the driving decoder weights are initialised to a set of random values. It will be appreciated that the term ‘random’ as used herein covers both ‘truly’ random and pseudorandom values and either type may be used as appropriate. The random initialisation may, in some embodiments, be performed using a pseudorandom number generator.

Thus in a particular set of embodiments, the driving model can be said to include three components—a video encoder, a world model, and a driving decoder. The first of these two (the video encoded and world model) may be pre-trained in an earlier training process, with the video decoder being trained separately.

As outlined above, the inputs to the driving decoder at inference time may include additional data such as a route map. Similarly, a route map may be provided during the training of the driving decoder. Thus, in some embodiments, training the driving decoder further comprises receiving a training route plan input corresponding to the further video training data, wherein the driving decoder is further configured to generate the new driving plan based on the training route plan input, optionally wherein the training route plan input comprises data representative of a route and/or a destination.

Thus the method may, in a particular set of embodiments, further comprise:
i) receiving a training route plan input corresponding to the further video training data;
ii) generating the new driving plan based on the training route plan input, optionally wherein the training route plan input comprises data representative of a route and/or a destination.

While the world model is pre-trained, the Applicant has appreciated that the weights of the world model may also be updated when the driving decoder is being trained. Thus, in some embodiments, the set of world model weights based on the difference between the new driving plan and the driving plan prior corresponding to the further video training data. This allows for ‘fine-tuning’ of the world model.

When viewed from a fourth aspect, embodiments of the present invention provide a method of training an autonomous driving system, the method comprising:
a) training a world model to generate a world state from video input data, wherein the world state comprises an implicit representation of candidate future events, the step of training the world model comprising:
   i) receiving video training data, said video training data comprising a plurality of time-varying image frames;
   ii) encoding the image frames to generate image encodings;
   iii) generating a sequence of input tokens from the image encodings; and
   iv) using an autoregressive transformer to model the sequence, thereby generating a trained world model having a set of learned world model weights.

This fourth aspect extends to a non-transitory computer-readable medium comprising instructions which, when executed by a processor, cause the processor to carry out a method of training an autonomous driving system, the method comprising:
a) training a world model to generate a world state from video input data, wherein the world state comprises an implicit representation of candidate future events, the step of training the world model comprising:
   i) receiving video training data, said video training data comprising a plurality of time-varying image frames;
   ii) encoding the image frames to generate image encodings;
   iii) generating a sequence of input tokens from the image encodings; and
   iv) using an autoregressive transformer to model the sequence, thereby generating a trained world model having a set of learned world model weights.

This fourth aspect extends to a computer software product comprising instructions which, when executed by a processor, cause the processor to carry out a method of training an autonomous driving system, the method comprising:
a) training a world model to generate a world state from video input data, wherein the world state comprises an implicit representation of candidate future events, the step of training the world model comprising:
   i) receiving video training data, said video training data comprising a plurality of time-varying image frames;
   ii) encoding the image frames to generate image encodings;
   iii) generating a sequence of input tokens from the image encodings; and
   iv) using an autoregressive transformer to model the sequence, thereby generating a trained world model having a set of learned world model weights.

When viewed from a fifth aspect, the present invention provides a world model for use in an autonomous driving system, said world model having a set of pre-trained world model weights, wherein the world model is configured to:
i) receive a sequence of input tokens comprising image encodings; and
ii) generate a world state based on said sequence, wherein the world state comprises an implicit representation of candidate future events.

In certain embodiments of any of the foregoing aspects of the invention, a trainable image encoder may be used for encoding the image frames to generate the image encodings. In some embodiments, the method comprises training a set of image encoder weights of the image encoder. The image encoder may be pre-trained.

In some such embodiments, the trained set of image encoder weights of the image encoder are used for encoding the further image frames to generate further image encodings. In other words, the same image encoder weights used for encoding the images when training the world model are used for encoding images later for use with the resultant trained world model used in conjunction with the driving decoder. Thus the world model may be trained to produce the world state (which in turn is usable as a latent state for the driving model), and the image encoder may be trained to encode the images in a manner suitable for input to that world model. That trained image encoder and world model may then readily be used as part of the driving model, together with the driving decoder discussed previously.

Each image frame may be encoded and discretized into a plurality of tokens for input into the world model. The image frames may be downsampled by a rate D.

The Applicant has appreciated that different modalities may be used to train the world model, with additional modalities beyond video or image data alone providing data on which the world model can be trained, enhancing the patterns it is able to learn from the sequences of data it is provided during training.

In some embodiments, the step of training the world model further comprises:
i) receiving action training data, said action training data comprising a plurality of time-varying driving actions;
ii) encoding the driving actions to generate action encodings;
iii) temporally aligning the image encodings and action encodings; and
iv) generating the sequence of input tokens from the temporally aligned image encodings and action encodings.

These driving actions correspond to driving parameters, such as a speed, a curvature, amounts of acceleration or braking being applied, a steering angle, an acceleration rate, a braking rate, a curvature rate, or such like. The driving actions may be raw signals, or may be formatted in some suitable manner, e.g. provided in a vectorised form. The driving action data may comprise a scalar value representing each driving parameters (e.g. a scalar representing speed, a scalar representing curvature, etc.).

In some such embodiments, a trainable action encoder is used for encoding the driving actions to generate the action encodings, wherein the method comprises training a set of action encoder weights of the action encoder. The action encoder may be pre-trained.

In some embodiments, the step of training the world model further comprises:
i) receiving textual training data, said textual training data comprising a plurality of time-varying text data;
ii) encoding the text data to generate text encodings;
iii) temporally aligning the image encodings and text encodings; and
iv) generating the sequence of input tokens from the temporally aligned image encodings and text encodings.

The textual data provided may be a text-based description of a particular scenario. For example, textual training data may comprise text statements such as “I am approaching a crossing yielding to pedestrians” or “It is safe to move so I am now accelerating”.

In some such embodiments, a trainable text encoder is used for encoding the text data to generate the text encodings, wherein the method comprises training a set of text encoder weights of the text encoder. The text encoder may be pre-trained.

In some embodiments, the step of training the world model further comprises:
i) receiving auxiliary sensor training data, said auxiliary sensor training data comprising a plurality of time-varying data relating to measurements from one or more auxiliary sensors;
ii) encoding the auxiliary sensor data to generate auxiliary sensor encodings;
iii) temporally aligning the image encodings and auxiliary sensor encodings; and
iv) generating the sequence of input tokens from the temporally aligned image encodings and auxiliary sensor encodings.

The auxiliary sensor data corresponds to measurements acquired from any auxiliary sensor(s) on the vehicle. Such auxiliary sensors may, in some embodiments, comprise one or more of: a radar sensor, a lidar sensor, an infrared sensor, a range sensor, a distance sensor, an ultrasonic sensor, a rain sensor, a temperature sensor, a pressure sensor, and a load sensor. The auxiliary sensor data may be raw signals, or may be formatted in some suitable manner, e.g. provided in a vectorised form. The auxiliary sensor data may comprise a scalar value representing each measurement (e.g. a scalar representing distance to another vehicle ahead of the autonomous vehicle, an array of infrared values, etc.).

In some such embodiments, a trainable auxiliary sensor encoder is used for encoding the auxiliary sensor data to generate the auxiliary sensor encodings, wherein the method comprises training a set of auxiliary sensor encoder weights of the auxiliary sensor encoder. The auxiliary sensor encoder may be pre-trained.

Each modality (images, actions, text, and/or auxiliary sensor data, as appropriate) is encoded separately and then the encodings are aligned temporally such that the correct time-based sequence of contemporaneous events is preserved. The world model is then trained by using an autoregressive transformer that models the sequence of tokenised, time-ordered encodings.

In some embodiments, the world model is configured to generate output tokens, wherein the output tokens are input to a video decoder, said video decoder being configured to generate a video output comprising a plurality of generated image frames from the output tokens. Thus, in accordance with such embodiments, the video decoder can decode the tokens output by the world model back into video, thus providing for synthetically generated realistic driving videos to be output. The video decoder may be a video diffusion decoder.

The video decoder may be a trainable component. Thus, in some embodiments, the method may further comprise training a set of video decoder weights of the video decoder.

It will be appreciated that the optional features described hereinabove in respect of embodiments of the any aspect of the invention apply equally, where technically appropriate, to the other aspects of the invention outlined herein.

Where technically appropriate, embodiments of the invention may be combined.

Embodiments are described herein as comprising certain features/elements. The disclosure also extends to separate embodiments consisting or consisting essentially of said features/elements.

Technical references such as patents and applications are incorporated herein by reference.

Any embodiments specifically and explicitly recited herein may form the basis of a disclaimer either alone or in combination with one or more further embodiments.

In the context of this specification “comprising” is to be interpreted as “including”. Aspects of the invention comprising certain elements are also intended to extend to alternative embodiments “consisting” or “consisting essentially” of the relevant elements.

The term “vehicle” as used herein should be understood to mean any kind of vehicle intended to travel on roads where some mechanical and/or electrical propulsion is used to drive the vehicle, whether operated autonomously or not. This includes, but is not limited to: cars, motorbikes, trucks, buses, coaches, vans, lorries, campervans, motor caravans, minibuses, limousines, all-terrain vehicles (ATVs), tractors, and other such vehicles that are mechanically or electrically driven.

Where context allows (e.g. in respect of other vehicles detected by the autonomous vehicle), the term “vehicle” further extends to non-driven vehicles, i.e. those without mechanical or electrical propulsion. This includes, but is not limited to: bicycles, unicycles, tricycles, quadracycles, rickshaws, carts, wagons, horse-drawn carts or carriages, and other such vehicles that are not mechanically or electrically driven.

The terms “data” is used in different contexts herein to refer to digital information, such as that represented by known bit structures within one or more programming languages. In use, data may refer to digital information that is stored as bit sequences within computer memory.

Certain machine learning models may operate on structured arrays of data of a predefined bit format. Using terms of the art, these may be referred to as “vectors”, as used herein.

However, the term “vector” is understood by those skilled in the art to cover multidimensional arrays or “tensors” as well. It should be noted that for machine learning methods multidimensional arrays, e.g. with a defined extent in multiple dimensions, may be “flattened” so as to be represented (e.g., within memory) as a sequence or vector of values stored according to the predefined format (e.g., n-bit integer or floating point number, signed or unsigned). Hence, the term “tensor” as used herein covers multidimensional arrays with one or more dimensions (e.g., vectors, matrixes, volumetric arrays etc).

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Certain embodiments of the present invention will now be described with reference to the accompanying drawings, in which:

FIG. 1: GAIA-1 multimodal video generation. GAIA-1 can generate videos by performing future rollouts starting from a video prompt. These future rollouts can be further conditioned on actions to influence particular behaviors of the ego-vehicle (e.g. steer left), or on text to drive a change in some aspects of the scene (change the color of the traffic light). For speed and curvature we condition the model by passing the sequence of future speed and/or curvature values. Our model can also generate realistic videos from text prompts, or by simply drawing samples from its prior distribution (fully unconditional generation).

FIG. 2: Architecture of GAIA-1. First, we encode information from all input modalities (video, text, action) into a common representation: images, text and actions are encoded as a sequence of tokens. The world model is an autoregressive transformer that predicts the next image token conditioned on past image, text, and action tokens. Finally, the video decoder maps the predicted image tokens back to the pixel space, at a higher temporal resolution.

FIG. 3: Increasing semantic content of image tokens through DINO distillation. Visualization shows the top 3 PCA components of token embeddings mapped to RGB values. DINO-distilled tokens corresponding to a semantic class (e.g. vehicle, road, or sky) have similar embeddings.

FIG. 4: Video decoder training tasks. Each task is defined by masking ground truth images and context tokens. We pass noise as input for frames we want to predict. Tokens are provided for predicted frames except for video interpolation task where the diffusion process is guided solely by image context.

FIG. 5: Data sampling. The top row shows the empirical distribution and the sampled distribution for three features we selected to balance over during training: latitude, longitude and weather condition. Dashed lines indicate data outside of the range we balanced over. The bottom row shows the geographical heatmap of sampled latitude and longitude coordinates for the whole training set, the sampled training set and the geofenced validation set.

FIG. 6: Perplexity of the world model as a function of the position of the generated token. We consider the n=576 tokens of a single image frame. We compare the perplexity of the tokens from a real image, to those generated with the following strategies: argmax, sampling, or top-k. In (a), by inspecting the perplexity of a real image we notice it oscillates between low and high values, meaning there is a good range of diversity in those tokens. In contrast, if we look at the argmax strategy, we notice the perplexity only takes extremely low values (no diversity, manifesting in the predicted frames to repeat themselves). Conversely in (b), if we sample from the entire distribution, the perplexity of some tokens can take extremely high values, due to sampling from the unreliable tail. In (c), we observe that top-k=50 sampling produces tokens that have a similar perplexity distribution to real tokens.

FIG. 7: Classifier-free guidance.

FIG. 8: Validation and training cross-entropy of the world model.
(a) The final performance of the GAIA-1 world model could be predicted with smaller models trained with less than 20× the compute.
(b) Training loss curves for world models up to 10,000× smaller. We used an exponential moving average to smooth the training loss curves.

FIG. 9: Images generated by GAIA-1, highlighting the diversity of the generated driving scenes.

FIG. 10: Long, diverse driving scenarios generated entirely from imagination by the world model.

FIG. 11: Examples of multiple plausible futures predicted by the world model from a given video context. 1) We observe a complex giving way interaction between the white vehicle and the ego vehicle. In the first future, the white vehicle reverses to give way to the ego-vehicle. In the second future, the opposite occurs and the ego-vehicle slows down to give way to the white vehicle. 2) We see two plausible ego-behaviors: going straight or turning right at the roundabout. 3) The model predicts two futures with varying traffic levels.

FIG. 12: Generation from a text prompt, showing that the world model has learned different concepts such as weather or illumination.
(a) Weather.
(b) Illumination.

FIG. 13: The world model can predict different outcomes conditioned on its actions. In the first four rows, we execute different out-of-distribution actions (left, strong left, right, strong right—while maintaining speed) from a given context video. The world model can predict the corresponding states with accurate geometry. In the last row, we force the ego-vehicle to steer right while maintaining speed, and as a consequence, we observe the oncoming vehicle reacting and making a maneuver to avoid a collision.

FIG. 14: Architecture used for a driving model, using the pre-trained world model.

### DETAILED DESCRIPTION

Certain exemplary embodiments are described herein which relate to an autonomous vehicle, control systems for autonomous vehicles, and methods of training such control systems. It will be appreciated that the autonomous vehicle and its various components—as well as systems and components it interacts with—are complex technical systems, and so the illustrations and descriptions provided herein are simplified for ease of reference.

It will be appreciated that this description provides examples for reference purposes, and the scope of the invention is defined by the claims.

In Chapter I of the following description, we explain in detail a generative world model for autonomous driving, where such a world model may be used to enable autonomous driving in accordance with embodiments of the present invention. In particular, a detailed outline of the Applicant's GAIA-1 model is set out hereinbelow.

In Chapter II, the description explains how such a model may then be used for autonomous driving in conjunction with a driving decoder, in accordance with embodiments of the present invention.

Note that numerals within square brackets, e.g. “[1]”, refer to the references provided later.

### 1. Generative World Model for Autonomous Driving

### 1. Introduction

Predicting future events is a fundamental and critical aspect of autonomous systems. Accurate future prediction enables autonomous vehicles to anticipate and plan their actions, enhancing safety and efficiency on the road. To achieve this, the development of a robust model of the world is imperative [1] and huge efforts have been made in the past to build such predictive world models for autonomous driving [2, 3, 4, 5, 6]. A world model [7, 8] learns a structured representation and understanding of the environment that can be leveraged for making informed decisions when driving.

However, current approaches have had significant limitations. World models have been successfully applied to control tasks in both simulation [9, 10, 11, 12, 13] and to real-world robotics tasks [14, 15]. These methods often rely on labelled data, which is challenging to obtain at scale, and models that work on simulated data may not fully capture the complexities of real-world scenarios. Furthermore, due to their low-dimensional representations, these models may struggle to generate highly realistic samples of future events, posing challenges in achieving a high level of fidelity in predictions for complex real-world applications such as autonomous driving.

Meanwhile, progress in generative image and video generation has harnessed the power of self-supervised learning to learn from large quantities of real-world data to generate remarkably realistic video samples [16, 17, 18]. Yet, a significant challenge persists in this domain: the difficulty of learning a representation that captures the expected future events. While such generative models excel at generating visually convincing content, they may fall short in learning representations of the evolving world dynamics that are crucial for precise future predictions and robust decision-making in complex scenarios.

In this work we introduce GAIA-1, a method designed with the goal of maintaining the benefits of both world models and generative video generation. It combines the scalability and realism of generative video models with the ability of world models to learn meaningful representations of the evolution into the future. GAIA-1 works as follows. First, we partition the model into two components: the world model and the video diffusion decoder. The world model reasons about the scene's high-level components and dynamics, while the diffusion model takes on the responsibility of translating latent representations back into high-quality videos with realistic detail.

For the world model, we use vector-quantized representations of video frames to discretize each frame, transforming them into a sequence of tokens. Subsequently, we reframe the challenge of predicting the future into predicting the next token in the sequence [10, 19]. This approach has been widely employed in recent years to train large language models [20, 21, 22, 23], and it is recognized for its effectiveness in enhancing model performance through the scaling of model size and data. It is possible to generate samples within the latent space of the world model through autoregressive generation.

The second component is a multi-task video diffusion decoder that is able to perform high-resolution video rendering as well as temporal upsampling to generate smooth videos from the information autoregressively generated by the world model. Similarly to large language models, video diffusion models have demonstrated a clear correlation between scale of training and overall performance, making both components of GAIA-1 suitable for effective compound scaling.

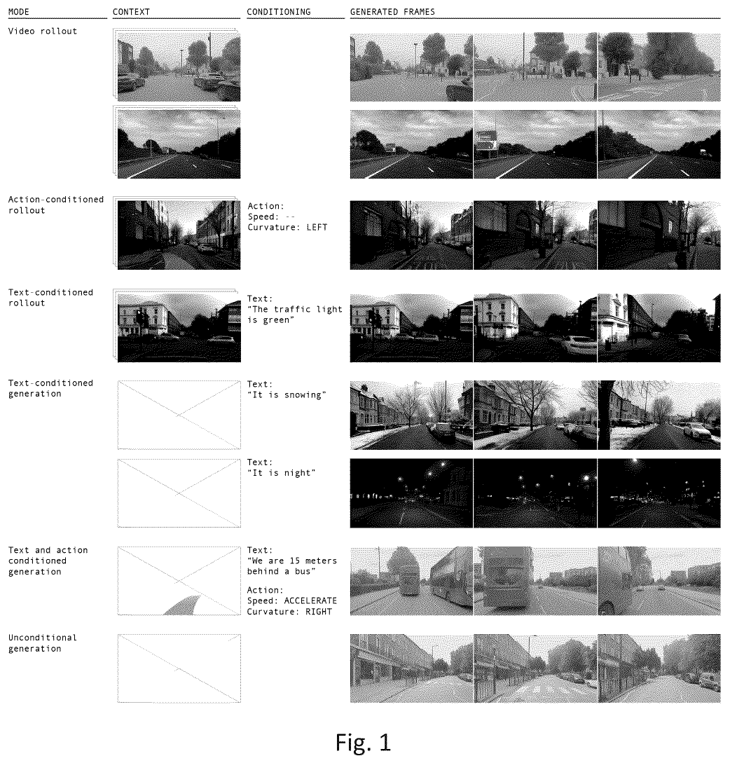

GAIA-1 is designed to be multimodal, allowing video, text and action to be used as prompts to generate diverse and realistic driving scenarios, as demonstrated in FIG. 1. By training it on a large corpus of real-world UK urban driving data, GAIA-1 learns to understand and disentangle important concepts such as static and dynamic elements, including cars, buses, pedestrians, cyclists, road layouts, buildings, and even traffic lights. Further, it provides fine-grained control over both ego-vehicle behavior and other scene features through action and language conditioning.

GAIA-1 demonstrates the ability to manifest the generative rules of the real world. Emerging properties such as learning high-level structures, generalization, creativity, and contextual awareness indicate that the model can comprehend and reproduce the rules and behaviors of the world. Moreover, GAIA-1 exhibits understanding of 3D geometry, for example, by effectively capturing the intricate interplay of pitch and roll induced by road irregularities such as speed bumps. It showcases reactive behaviors of other agents demonstrating the ability to understand causality in decision making of road users. Surprisingly, it shows the capability to successfully extrapolate beyond the training data, for example to driving outside of the boundaries of the road. See Section 7 for a comprehensive list of examples.

The power of GAIA-1's learned representations to predict future events, paired with control over both ego-vehicle dynamics and scene elements, is an exciting advance that paves the way for improving embodied intelligence and providing synthetic data to accelerate training and validation. World models, such as GAIA-1, are the basis for the ability to predict what might happen next, which is fundamentally important for decision-making in autonomous driving.

### 2. Model

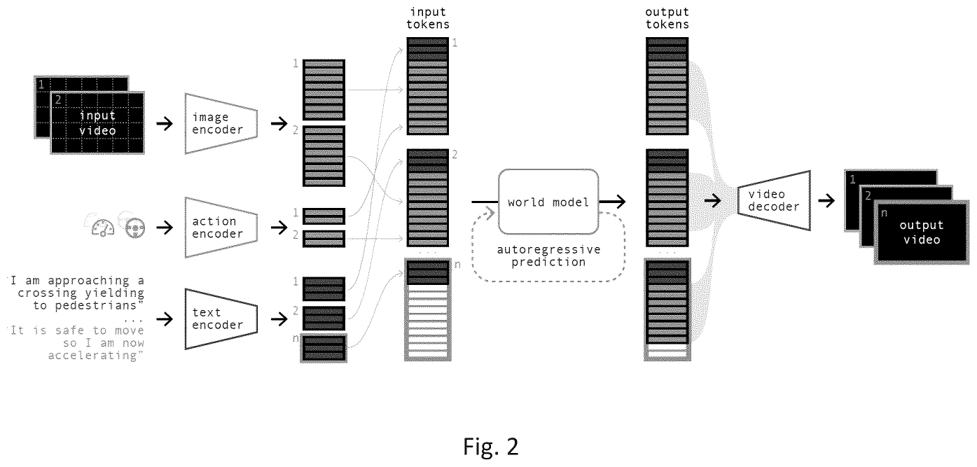

In this section we describe the model architecture of the trainable components of GAIA-1. The general architecture is presented in FIG. 2.

### 2.1 Encoding Video, Text, and Action

GAIA-1 can leverage three different input modalities (video, text, action), which are encoded into a shared d-dimensional space.

Image tokens. Each image frame of a video is represented as discrete tokens. To achieve this, we use a pre-trained image tokenizer for discretization (for details about the pre-training see Section 2.2).

Formally, let us consider a sequence of T images (x₁, . . . , x_{T}), where each image x_{T} in this sequence is discretized into n=576 discrete tokens using the pre-trained image tokenizer. We obtain a sequence denoted as (z₁, . . . , z_{T}), where each zₜ=(z_{t,1}, . . . , z_{t,n})ϵ [symbol] ⁿ corresponds to

$$n = \frac{H}{D} \times \frac{W}{D}$$

discrete tokens. Here, H and W represent the height and width of the input image, while D denotes the downsampling factor of the image tokenizer. These discrete tokens are then mapped to a d-dimensional space via an embedding layer that is trained alongside the world model.

Text tokens. At each time step t, we incorporate information from both text and action. Textual input is encoded using the pre-trained T5-large model [24], resulting in m=32 text tokens per time step. These tokens are mapped to a d-dimensional space through a linear layer that is trained in conjunction with the world model. This process yields a text representation denoted as cₜ=(c_{t,1}, . . . , c_{t,m})ϵ [symbol] ^{m×d}.

Action tokens. For actions, we consider l=2 scalar values (representing speed and curvature). Each scalar is independently mapped to the d-dimensional space via a linear layer that is trained with the world model. Consequently, the action at time step t is represented as aₜ=(a_{t,1}, . . . , a_{t,l})ϵ [symbol] ^{l×d}.

For each time step, the input tokens are interleaved in the following order: text—image—action. The final input of the world model is therefore (c₁, z₁, a₁, . . . , c_{T}, z_{T}, a_{T}). To encode the position of the input tokens, we use a factorized spatio-temporal positional embedding. 1) A learnable temporal embedding is shared across all the tokens of a given time step, i.e. there are T temporal embeddings. 2) A learnable spatial embedding indicates the position of a token within a time step, i.e. there are m+n+l=610 spatial embeddings (m text tokens, n image tokens, and I action tokens) of dimension d=4096.

### 2.2 Image Tokenizer

When modeling discrete input data with a sequence model, there is a trade-off between the sequence length and the vocabulary size. The sequence length refers to the number of discrete tokens that are needed to describe the data. The vocabulary size corresponds to the number of possible values a single token can take. For language, there are two obvious choices for tokens: characters and words. When using character-level tokens, the input data has a longer sequence length, and each individual token belongs to a smaller vocabulary, but conveys little meaning. When using word-level tokens, the input data has a shorter sequence length, and each token contains a lot of semantics but the vocabulary is extremely large. Most language models [25, 26, 24, 21, 27, 22] use byte-pair encoding (or equivalent) as a trade-off between character-level and word-level tokenization.

Likewise for video, we would like to reduce the sequence length of the input, while possibly making the vocabulary larger, but with tokens that are more semantically meaningful than raw pixels. We do this with a discrete image autoencoder [28]. There are two objectives we would like to achieve in this first stage:
1. Compress the information from raw pixels to make the sequence modeling problem tractable. Images contain a lot of redundant and noisy information. We would like to reduce the sequence length needed to describe the input data.
2. Guide the compression towards meaningful representations, such as semantics, instead of high-frequency signals. The resulting input space for the world model will be simpler to compose with, and less dominated by high-frequency signals that can considerably slow down the learning process.

We reduce the sequence length of the input data by downsampling each input image by a factor D=16 in both height and width. Each image xₜ of size H×W is described by

$$n = \frac{H}{D} \times \frac{W}{D}$$

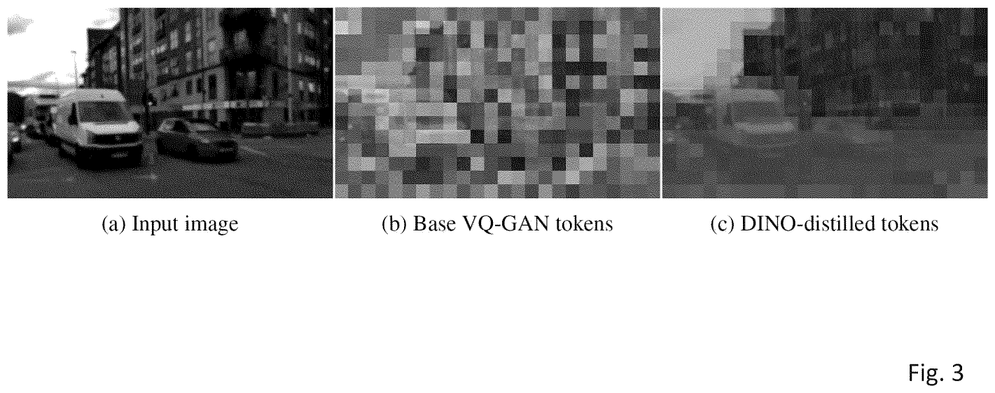

tokens with a vocabulary size K. Inspired by [29], we guide the compression towards meaningful representations by regressing to the latent features of a pre-trained DINO model [30], a self-supervised image model that is known to contain semantic information. See FIG. 3 for a qualitative example.

The discrete autoencoder is a fully convolutional 2D U-Net [31]. The encoder E_{B} quantizes the image features using nearest neighbor look-up from a learnable embedding table [28], resulting in image tokens zₜ=E_{θ}(xₜ). Note that the decoder is only used to train the image autoencoder, solely the discrete encoder E_{θ} is part of the final GAIA-1 model. Due to the decoder being trained on single images it lacks temporal consistency when decoding to a video. For this reason we also train a video decoder that is described in Section 2.4.

The training losses for the image autoencoder are the following:
Image reconstruction loss. The image reconstruction loss is a weighted sum of L₁, L₂, perceptual loss L_{perceptual} [32], and GAN loss L_{GAN} [33].
Quantization loss. To update the embedding vectors, we use the embedding loss and the commitment loss from [28]. We adopted the linear projection of the embedding and L₂ normalization from [34] as we found this helped increase vocabulary usage.
Inductive bias loss. The quantized image features are encouraged to match the image features of a pre-trained DINO [30] model with a cosine similarity loss. Distilling the information from DINO into the learned tokens is important as it allows them to benefit from the inductive biases of this model.

### 2.3 World Model

As described in Section 2.1 the input of the world model is (c₁, z₁, a₁, . . . , c_{T}, z_{T}, a_{T}). The world model is an autoregressive transformer network that models the sequence input. Its training objective is to predict the next image token in the sequence conditioned on all past tokens, using causal masking in the attention matrix of the transformer blocks [35].

$${L}_{world model} = - {\sum }_{t = 1}^{T} {\sum }_{i = 1}^{n} log p ( {z}_{t , i} \vert {z}_{< t} , {z}_{t , j < i} , {c}_{< t} , {a}_{< t} )$$

We randomly dropout conditioning tokens during training so that the world model can do (i) unconditional generation, (ii) action-conditioned generation, and (iii) text-conditioned generation.

To further reduce the sequence length of our world model we temporally subsample videos from 25 Hz to 6.25 Hz. This allows the world model to reason over longer periods without leading to intractable sequence lengths. To recover video predictions at full frame rate we perform temporal super-resolution using the video decoder described in Section 2.4.

### 2.4 Video Decoder

Following the recent advances in image [36, 37] and video generation [16, 18] we use denoising video diffusion models for the GAIA-1 decoder. A naive approach of independently decoding each frame-tokens to pixel space results in a temporally inconsistent video output. Modeling the problem as denoising a sequence of frames during the diffusion process, where the model can access information across time, greatly improves temporal consistency of the output video.

We follow [38] and use a 3D U-Net with factorized spatial and temporal attention layers. During training, our video diffusion model is conditioned on the image tokens obtained by discretizing input images with the pre-trained image tokenizer E_{θ}. During inference, the diffusion model is conditioned on the predicted image tokens from the world model.

We train a single model jointly on both image and video generation tasks. Training on videos teaches the decoder to be temporally consistent, while training on images is crucial for the quality of individual frames [16] as it teaches the model to extract information from conditioning image tokens. We disable temporal layers when training on images.

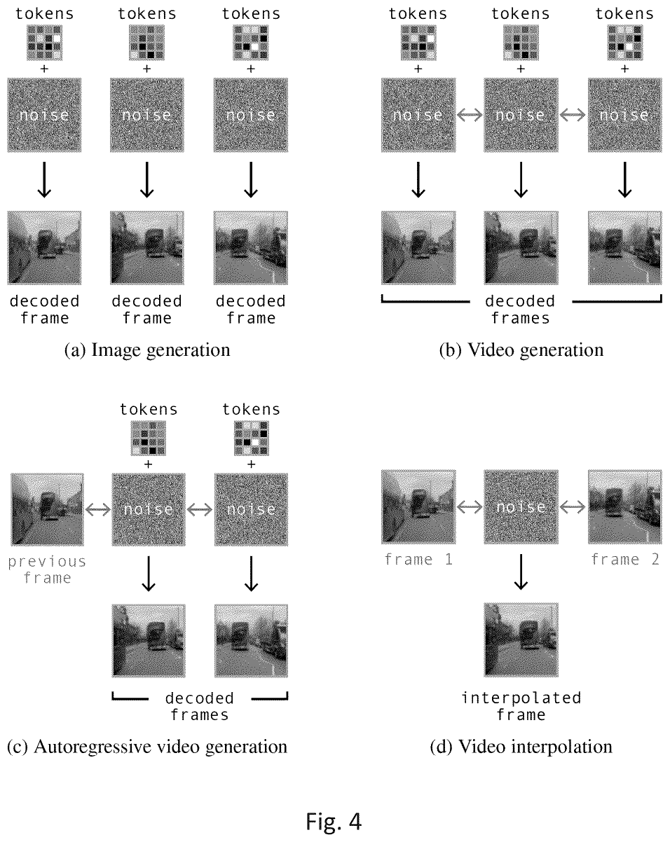

To train our video diffusion decoder for multiple inference tasks we take inspiration from [17] where we can perform multiple tasks by masking certain frames or the conditioning image tokens. We choose to train a single video diffusion model for all tasks as it has been shown that multi-task training improves performance on individual tasks [17]. The tasks include image generation, video generation, autoregressive decoding, and video interpolation. Each task is sampled equally. For example, for the autoregressive generation task, we provide previously generated past frames as context and conditioning image tokens for frames we want to predict. We include both forward and backward autoregressive tasks. See FIG. 4 for examples of each task. We also apply a conditioning dropout by randomly masking out each conditioning image token with probability p=0.15 as it helps the model generalize beyond relying on tokens for information and improves temporal consistency.

The video decoder is trained on the noise prediction objective. More specifically, we use the v-parameterization as proposed in [39] because it avoided unnatural color shifts and maintained long-term consistency as similarly found in [16]. In practice, we use a weighted average of L₁ and L₂ losses. The video decoder loss L_{video} is:

$${L}_{video} = {𝔼}_{ϵ , {t}^{′}} [ {‖ {ϵ}_{θ} ( {x}^{{t}^{′}} , {t}^{′} , z , m ) - ϵ ‖}_{2}^{2} ]$$

where:
ϵ_{θ} is the denoising video model.
ϵ is the denoising target, which uses the v-parameterization.
t′˜U(0, 1) is the sampled discrete diffusion time.
x=(x₁, . . . , x_{T′}) is a video sequence of length T′.
x_{t′}=α_{t′}x+σ_{t′}ϵ represents the noised video, with α_{t′} and σ_{t′} functions of t′ that define the noise schedule.
z=(z₁, . . . , z_{T′})=E_{θ}(x) is the sequence of conditioning image tokens.
m=(m₁, . . . , m_{T′}) is a sequence of image masks as specified by the training task (see FIG. 4).

### 3. Data

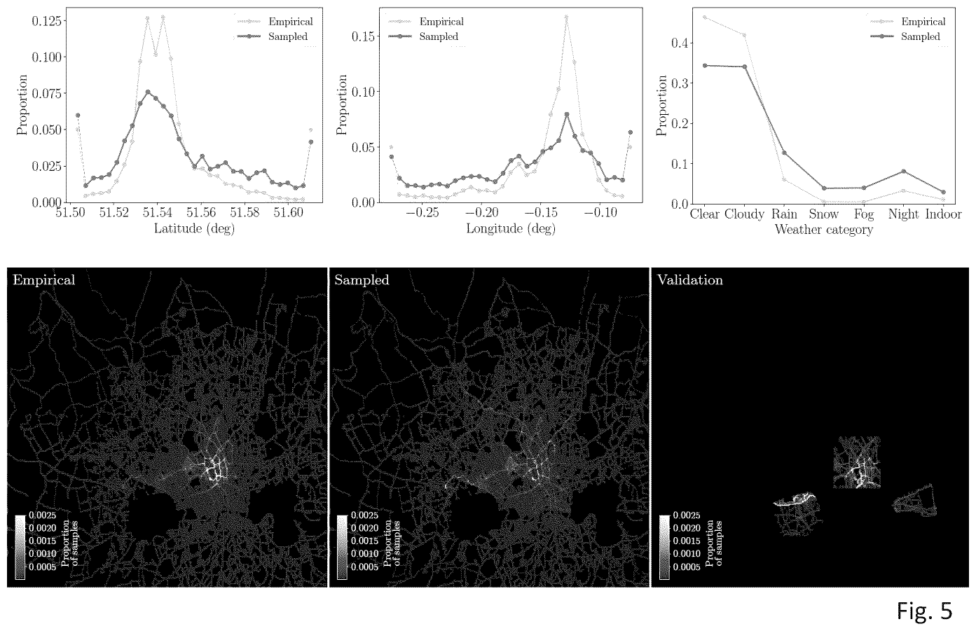

Our training dataset consists of 4,700 hours at 25 Hz of proprietary driving data collected in London, UK between 2019 and 2023. This corresponds to approximately 420M unique images. During training we balance over a customizable set of features to control the distribution of data (FIG. 5). We achieve this by sampling individual data points with weighting inversely proportional to the (binned and precomputed) empirical distribution of a given feature. For a given example we take the joint probability across all features to balance and stochastically decide whether to include or discard that example. We can control the strength of balancing by raising the sampling weight to an exponent, where an exponent of 0 would result in the empirical distribution (no balancing) and an exponent of 1 would result in a uniformly balanced distribution. We used an exponent of 0.5 for all features as a compromise between final balancing achieved and the severity of discarding samples for training efficiency.

For the tokenizer we balanced over (latitude, longitude, weather category) to account for geography and visually distinct weather conditions ensuring our tokenizer can adequately represent a diverse range of scenes.

For the world model and the video diffusion model we balanced over (latitude, longitude, weather category, steering behavior category, speed behavior category), additionally considering speed and steering behaviors to ensure the dynamics of different behaviors are captured and sufficiently modelled by the world model and the temporal decoder.

Our validation dataset contains 400 hours of driving data from runs not included in the training set. The runs selected for validation are those that pass through predetermined geofences as well as a selection of randomly selected runs. We further split our validation set into strict geofences in order to analyze only those samples strictly within the validation geofence (i.e., roads never seen during training) and another geofence around our main data collection routes (i.e., roads seen during training) as a way to monitor overfitting and generalization.

### 4. Training Procedure

In this section, we describe how the three trainable components of GAIA-1 were optimized. We provide details of hyperparameter configurations, hardware used and training times.

### 4.1 Image Tokenizer

The image tokenizer (0.3B parameters) was trained on images of resolution H×W=288×512 (9/16 ratio). The spatial downsampling of the encoder is D=16, therefore each image is encoded as n=18×32=576 discrete tokens with a vocabulary size K=8192. The bit compression is

$$\frac{288 \times 512 \times 3 \times 8}{18 \times 32 \times 13} \approx 470 .$$

The discrete autoencoder was optimised with AdamW [40] and a learning rate of 1×10⁻⁴, weight decay 0.01, beta coefficients (0.5, 0.9). The loss weights are λ_{L}_{₁}=0.2, λ_{L}_{₂}=2.0, λ_{L}_{_{perceptual}}=0.1, λ_{L}_{_{GAN}}=1.0, λ_{L}_{_{codebook}}=1.0, λ_{L}_{_{DINO}}=0.1.

The model was trained for 200 k steps in 4 days with a batch size equal to 160, split across 32 A100 80 GB GPUs. We used 5 k of linear warm-up and 10 k of cosine decay to a final learning rate of 1×10⁻⁵.

### 4.2 World Model

The world model (6.5B parameters) was trained on video sequences of size T=26 at 6.25 Hz, which correspond to 4 s-long videos. The text was encoded as m=32 text tokens per time step, and the action as l=2 tokens. The total sequence length of the world model is therefore T×(m+n+l)=15860.

The world model was optimized with AdamW and a learning rate of 1×10⁻⁴, weight decay 0.1, beta coefficients (0.9, 0.95), norm gradient clipping 1.0. Training examples were either unconditioned, action-conditioned, or text conditioned. The ratios of these respective conditioning modes were 20%/40%/40%.

The model was trained for 100 k steps in 15 days, with 2.5 k of linear warm-up and 97.5 k of cosine decay reducing the learning rate by a factor of 10 over the course of training. The batch size was 128 split across 64 A100 80 GB GPUs. We used the FlashAttention v2 implementation [41] in the transformer module, as it offered significant advantages in terms of both memory utilization and inference speed. To optimize distributed training, we used the Deepspeed ZeRO-2 training strategy [42] with activation checkpointing.

### 4.3 Video Decoder

The video decoder (2.6B) was trained on sequences of T′=7 images of resolution H×W=288×512 sampled from the dataset at either 6.25 Hz, 12.5 Hz or 25 Hz. The training tasks (FIG. 4) were sampled with equal probability. We used a cosine β-noise schedule [43].

The video decoder was optimized with AdamW and a learning rate of 5×10⁻⁵, weight decay 0.01, beta coefficients (0.9, 0.99), norm gradient clipping 1.0. The model was trained for 300 k steps in 15 days, with 2.5 k of linear warm-up and 5 k of cosine decay to a final learning rate of 1×10⁻⁶. We used a weighted average of L₁ and L₂ losses with weights λ_{L}_{₁}=0.1 and λ_{L}_{₂}=1.0. The batch size was 64 split across 32 A100 80 GB GPUs. We used an exponential moving average for the parameters with a decay of 0.999. The training strategy was also Deepspeed ZeRO-2 with activation checkpointing.

### 5 Inference

In this section, we describe in more detail the inference procedure of the world model and the video decoder.

### 5.1 World Model

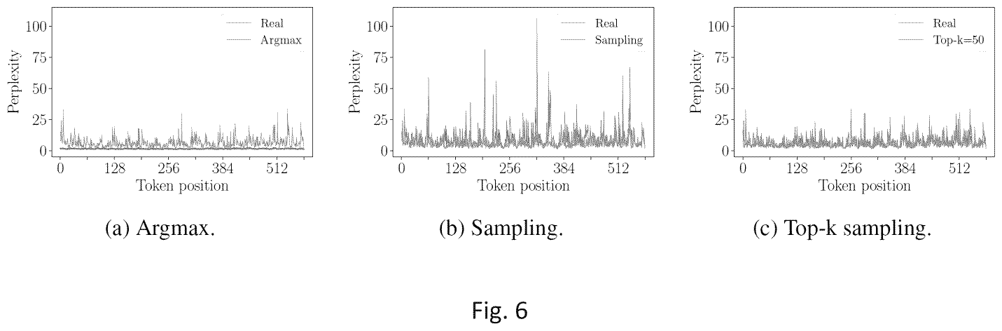

Sampling. The world model autoregressively predicts the next image token, conditioned on previous text, image and action tokens. Given the past tokens we perform n forward steps to generate one new image frame. At each step we must sample a token from the predicted logits to select the next token in our sequence. Empirically we observed that maximization-based sampling (i.e. argmax) generates futures that get stuck in a repetitive loop, similarly to language models [44]. Conversely, if we simply sample from the logits, the selected token can come from the unreliable tail of the probability distribution, which throws the model out-of-distribution, see FIG. 6.

To encourage diversity as well as realism we employ top-k sampling to sample the next image token from the top-k most likely choices. The chosen value of k is a function of the number of tokens that constitute an image frame as well as the pre-learnt codebook (vocabulary) size.

Our world model can be used to roll out possible futures given starting context as well as generating futures from scratch without any starting context. For long video generation, if the length of the video exceeds the context length of the world model, we employ a sliding window.

Text-conditioning. The video prediction can be prompted, and thus directed, with text. At training time, we condition our video sequences with text coming from either online narration or offline metadata sources. Because these text sources are imperfect, to improve the alignment between generated futures and the text prompt, we employ classifier-free guidance [45, 46] at inference time. The effect of guidance is to increase text-image alignment by decreasing the diversity of possible samples. More precisely, for each next token to predict, we compute logits conditioned on text as well as logits with no conditioning (unconditioned). At inference, we can then amplify the differences between the unconditioned and the text-conditioned logits with a scale factor to give the final logits used for sampling.

$${l}_{final} = ( 1 + t ) {l}_{conditioned} - {tl}_{unconditioned}$$

By substituting the unconditioned logits with those conditioned on another text prompt, we can perform “negative” prompting [47]. Pushing the logits away from the negative prompt and towards the positive one encourages the future tokens to include the “positive” prompt features while removing the “negative” ones.

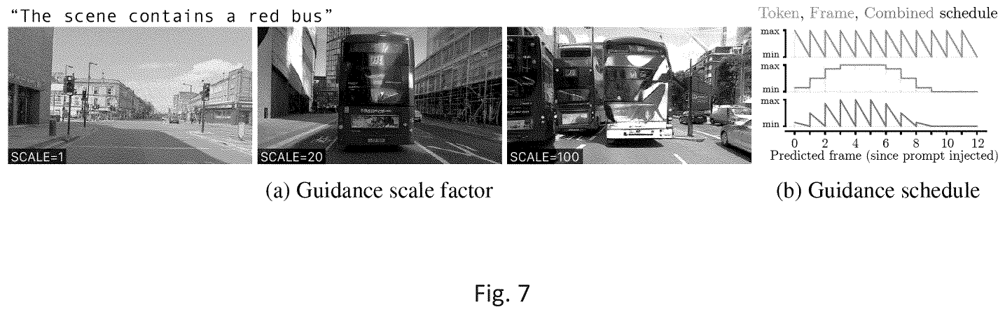

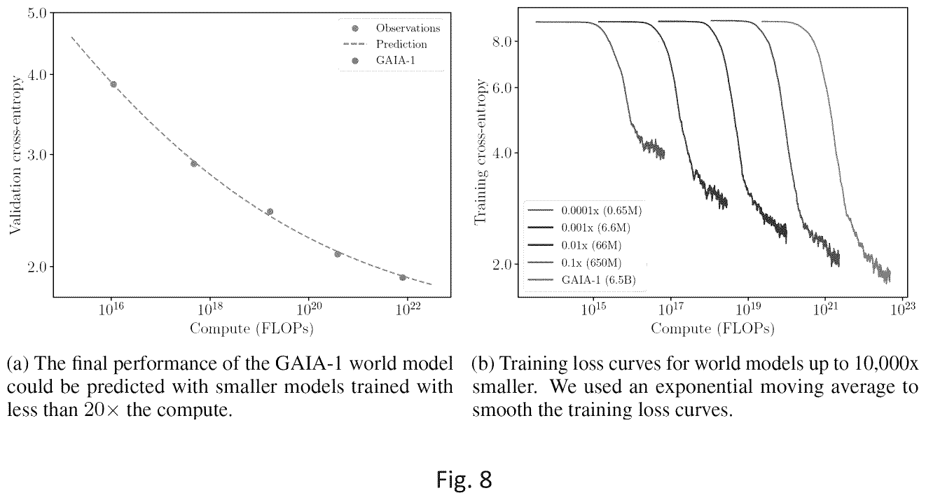

We found it was important to schedule the scale factor used for guidance over tokens as well as frames. Scheduling over tokens allows some to be sampled with high guidance (hence adhering strongly to the prompt) and others to be sampled with low guidance (hence increasing sample diversity). Scheduling over frames allows for controlling the transition from earlier frames as well as mitigating compounding guidance over subsequent consecutive frames. In FIG. 7 we show an example guidance schedule over twelve frames. Typically we used a schedule that sampled tokens with linearly decreasing guidance over tokens and we lowered the guidance over future frames with a cosine decay, with or without an initial plateau. We note that guidance scale and schedule are hyperparameters to be tuned to particular use cases.

### 5.2 Video Decoder

To decode a sequence of generated tokens from the world model, we use the following video decoding method:
1. Decode the first T′=7 frames, conditioned on the corresponding T′ image tokens.
2. Autoregressively decode the next T′−2 frames, using 2 past overlapping frames as image context, and the following T′−2 image tokens.
3. Repeat the autoregressive process until the N frames have been generated at 6.25 Hz.
4. Temporally upsample the N frames from 6.25 Hz to 12.5 Hz
5. Temporally upsample the 2N−1 frames from 12.5 Hz to 25.0 Hz

We use the DDIM sampler [48] with 50 diffusion steps. During autoregressive decoding, we see a trade-off between reflecting token information content in the generated video and temporal consistency. To balance between these two objectives, we calculate a weighted average of the two tasks [18].

$${\tilde{ϵ}}_{θ} ( {x}^{{t}^{′}} , {t}^{′} , z , m ) = ω \cdot {ϵ}_{θ}^{π} ( {x}^{{t}^{′}} , {t}^{′} , z , m ) + ( 1 - ω ) \cdot {ϵ}_{θ} ( {x}^{{t}^{′}} , {t}^{′} , z , m )$$

where function ϵθ^{π}(x^{t′}, t′, z, m) denoises each frame individually as images and function ϵ_{θ}(x^{t′}, t′, z, m) denoises the sequence of frames jointly as a video. In practice, we simply switch on and off the temporal layers. We apply this weighted average randomly for each diffusion step with probability p=0.25 and weight w=0.5.

While exploring different inference approaches for video decoding we found that decoding video frames autoregressively backwards starting from the end of the sequence led to more stable objects and less flickering on the horizon. In our overall video decoding method, we thus decode the last T′ frames and autoregressively decodes the remaining frames backward from there.

### 6 Scaling

The formulation of the world modeling task in GAIA-1 shares a commonality with the approach frequently used in large language models (LLMs). In both instances, the task is streamlined to focus on predicting the next token. Although this approach is adapted for world modeling in GAIA-1 rather than the traditional language tasks seen in LLMs, it is intriguing to observe that scaling laws [49, 21, 27], analogous to those observed in LLMs, are also applicable to GAIA-1. This suggests the broader applicability of scaling principles in modern AI models across diverse domains, including autonomous driving.

To explore scaling laws with GAIA-1, we predicted the final performance of the world model using models trained with less than 20× the compute. We evaluated those models on a held-out geofenced validation set by measuring cross-entropy. A power-law of the form

$$f ( x ) = c + {( \frac{x}{a} )}^{b}$$

was then fitted to the data points. In FIG. 8a we can see that the final cross-entropy of GAIA-1 could be predicted with high accuracy.

The models used to fit the power-law ranged from 10,000× to 10× smaller models in terms of parameters (0.65M to 650M), as visualized in FIG. 8b. Similarly to [49], the compute was estimated as a function of the parameter count. If we denote by C the compute and by N the parameter count (excluding embedding layers), the number of floating point operations for a forward-backward pass of a single token is given by C=6N. To obtain the total amount of compute, this value is multiplied by the number of training tokens.

It is worth noting that our extrapolation leads us to the conclusion that there is substantial potential for further improvement through the expansion of both data and computational resources.

### 7 Capabilities and Emerging Properties

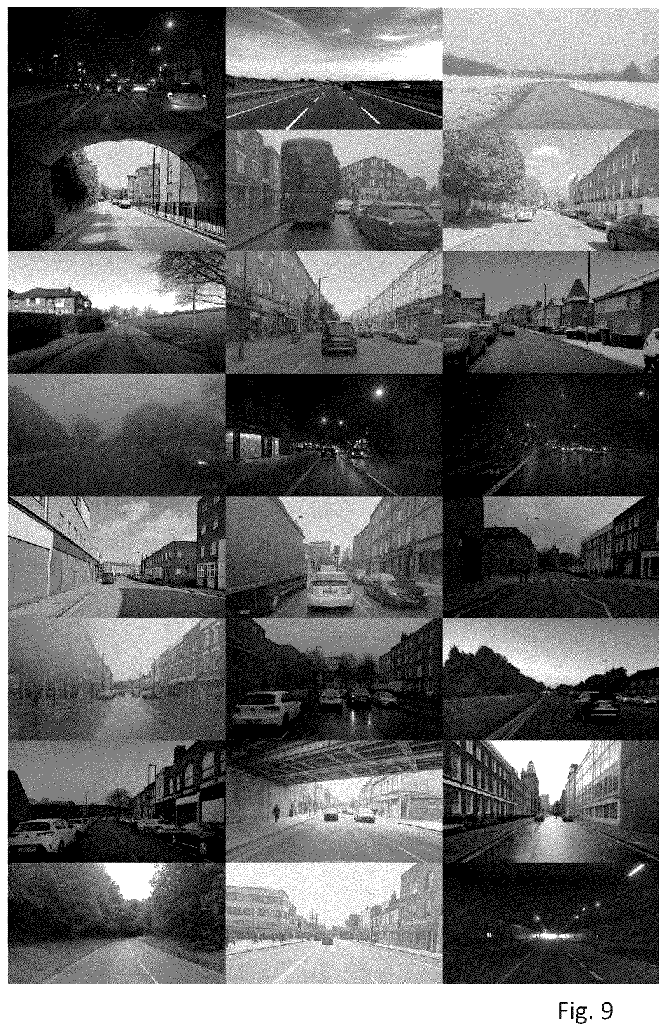

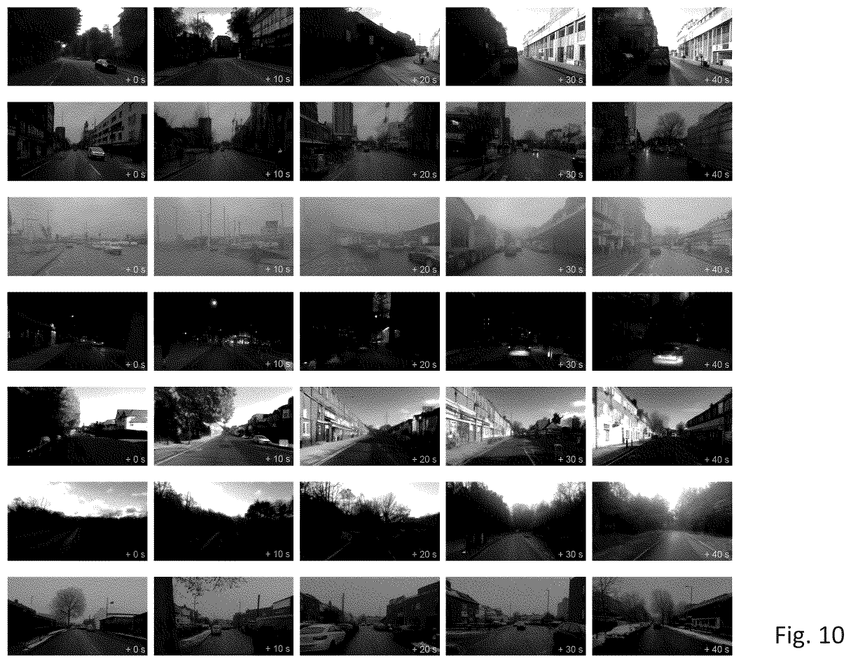

In this section we showcase the capabilities and emerging properties of GAIA-1 through a series of qualitative examples. The comprehensive list of video examples can be found at [95]. FIG. 9 shows the variety of scenarios that can be generated by our model. As evidenced by the examples presented in the rest of this section, GAIA-1 exhibits a level of understanding and summarization of the generative rules of the world through the following emergent properties:
1. Learning high-level structures and scene dynamics: it generates coherent scenes with objects positioned in plausible locations and exhibiting realistic object interactions, such as traffic lights, rules of the road, give ways, etc. This suggests that the model is not just memorizing statistical patterns but is understanding the underlying rules that govern the arrangement and behavior of objects in the world (see Section 7.1).
2. Generalization and creativity: it can generate novel and diverse videos that go beyond specific instances in the training set. It can produce unique combinations of objects, movements, and scenes that were not explicitly present in the training data, demonstrating remarkable extrapolation capabilities. This demonstrates a certain level of generalization and creativity, which suggests an understanding of the underlying generative rules that govern video sequences (see Section 7.2).
3. Contextual awareness: GAIA-1 can capture contextual information and generate videos that reflect this understanding. For example, it can generate coherent actions and responses in videos based on the initial conditions or the context provided. Moreover, GAIA-1 exhibits the understanding of 3D geometry, effectively capturing the intricate interplay of pitch and roll induced by road irregularities (e.g. speed bumps). This contextual awareness suggests that the models are not merely reproducing statistical patterns but are actively processing and summarizing the given information to generate appropriate video sequences (see Section 7.3).

### 7.1 Generation of Long Driving Scenarios

GAIA-1 can generate stable long videos (minutes) entirely from imagination (FIG. 10). In order to do this, the model leverages its learned implicit prior distribution of the world to generate fully imagined realistic driving scenarios, with complex road layouts, buildings, cars, pedestrians, and more. This is a demonstration that GAIA-1 understands the rules that underpin the world we inhabit and its structures and dynamics.

### 7.2 Generation of Multiple Plausible Futures

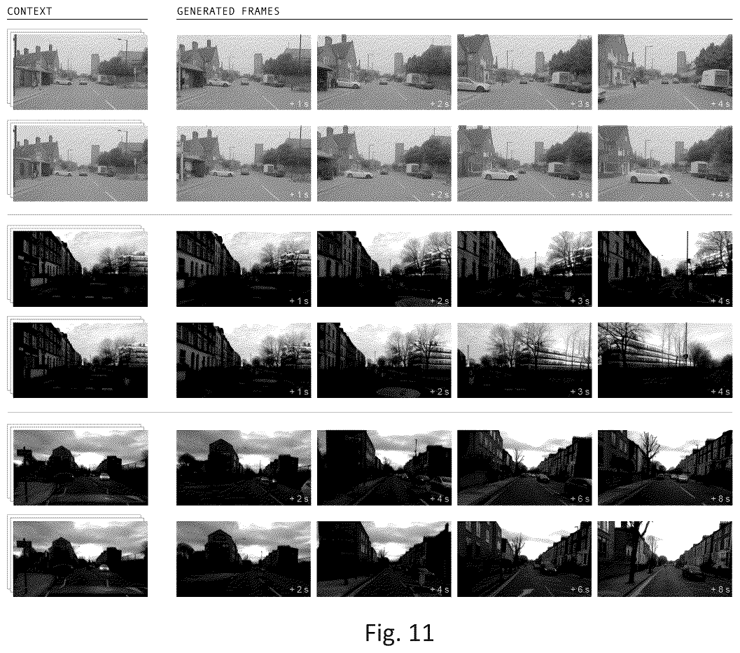

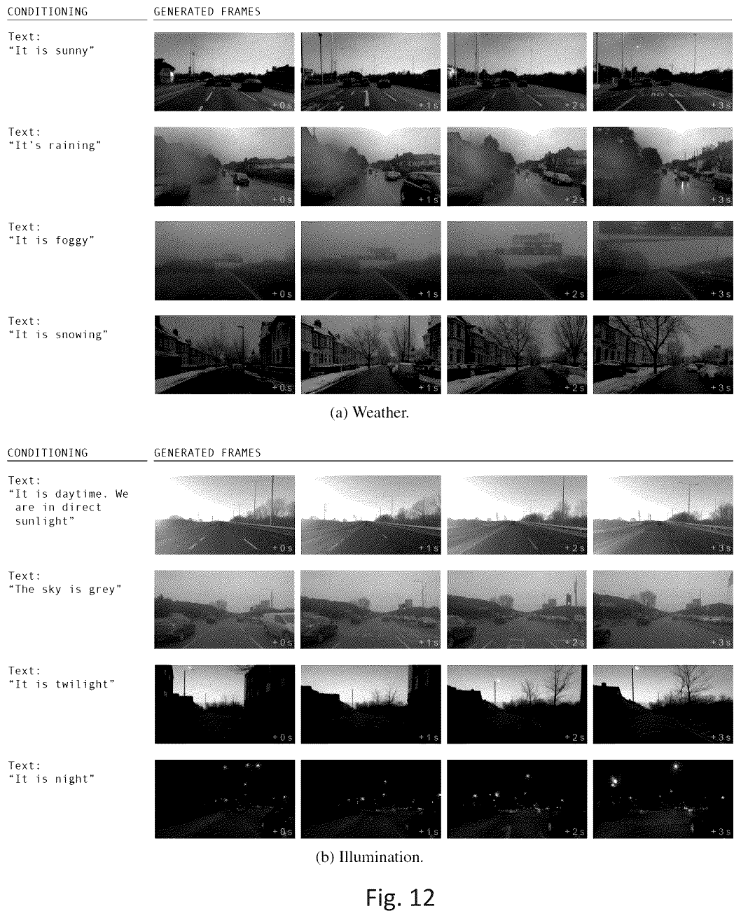

GAIA-1 has the ability to generate a variety of distinct future scenarios based on a single initial prompt. When presented with a brief video as context, it can generate numerous plausible and diverse outcomes by repeatedly sampling. GAIA-1 accurately models multiple potential future scenarios in response to the video prompt while maintaining consistency with the initial conditions observed in the video. As seen in FIG. 11, the world model can reason about (i) dynamic interactions with road users (e.g. giving way or not giving way), (ii) multimodal ego-behaviors (e.g. going straight or turning at a roundabout), and (iii) multimodal dynamic scene (e.g. variable traffic density and types of road users such as pedestrians, cyclists, motorcyclists, vehicles) and static scene (e.g. road layout, buildings, vegetation).

### 7.3 Fine-Grained Control of the Ego-Vehicle Behavior and Driving Scenes

GAIA-1 can generate videos from text prompts only, completely imagining the scene. To demonstrate this we showcase how we can generate driving scenarios from text prompts that guide the model towards specific weather or lighting conditions in FIG. 12.

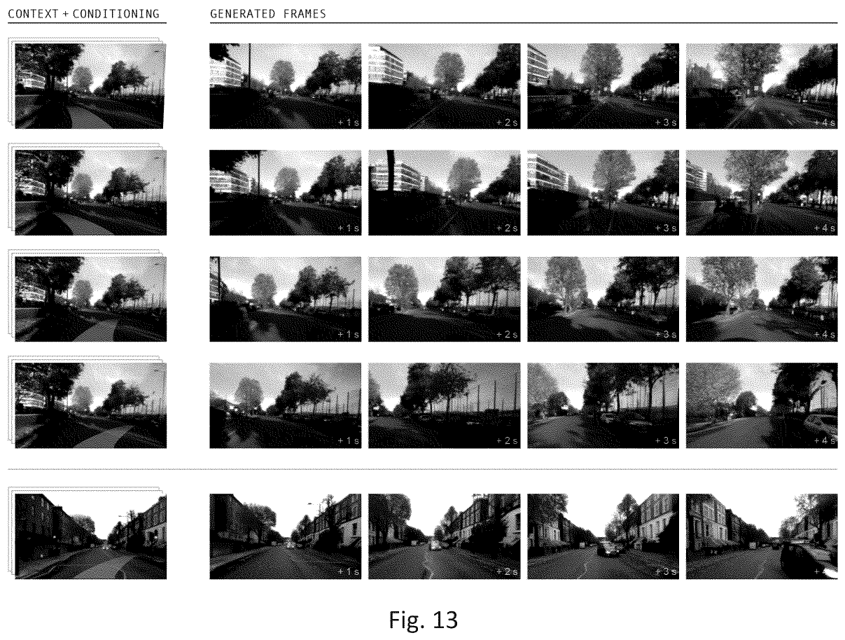

Next, we present compelling examples where the model exhibits fine-grained control over the vehicle dynamics in the video. By leveraging this control, we can prompt the model to generate videos depicting scenarios that lie outside the bounds of the training data. This shows that GAIA-1 is able to disentangle the ego-vehicle dynamics from the surrounding environment and effectively generalize to unfamiliar scenarios. It provides explicit ability to reason about the impact of our actions on the environment (safety), it allows richer understanding of dynamic scenes (intelligence), it unlocks model-based policy learning (planning in the world model), and it enables exploration in closed-loop (by considering the world model as a neural simulator). To showcase this, we make GAIA-1 generate futures where the ego-vehicle steers left or right, deviating from its lane (FIG. 13). GAIA-1 would never have seen these incorrect behaviors in the expert driving dataset used to train it, indicating that it can extrapolate driving concepts previously unseen in the training data. We also see realistic reactions of other agents to the ego-vehicle's controlled behavior. Finally we demonstrate the ability of GAIA-1 to leverage both text and action to fully imagine a driving scenario. In this particular case we prompt the model to generate a bus in front of the ego-vehicle and then we force its actions to overtake the bus (see FIG. 1).

### 8 Related Work

Video generative models. Video generative models are neural networks that can generate realistic video samples. They can be grouped in four categories: VAE-based (variational autoencoder [50], GAN-based (generative adversarial network [51]), diffusion-based [52], and autoregressive-based [53].

Latent-variable video models (VAE-based) try to infer the underlying latent process that generated the videos [54, 55, 56, 57, 58]. One known limitation of those models is that they tend to generate blurry outputs due to limited representational power, inadequate choice of prior distribution, and the optimization of a lower-bound instead of the true likelihood. GAN-based methods produce more realistic videos [59, 60, 61, 62, 63, 64] but are known to suffer from training instability and a lack of generation diversity [65]. Diffusion-based methods have yielded significant enhancements in realism, controllability, and temporal consistency. They can operate either at the pixel level [38, 17, 66, 67, 68, 69, 16] or in the latent space of a pre-trained image tokenizer [70, 18, 71].

Diffusion models are expressive neural networks that can fit complex data distributions, but rely on a long Markov chain of diffusion steps to generate samples. Lastly, autoregressive-based methods are conceptually simple and rely on tractable exact likelihood optimization (fits the entire data distribution). Likewise, they can operate at the pixel level [72, 73], or in a discrete learned token space [74, 75, 76, 77]. A known limitation is the slow generation speed, but this issue could be alleviated by future research on parallel sampling [78, 79, 80], reducing the number of latent variables [81], and improvements in hardware accelerators.

World models. A world model is a predictive model of the future that learns a general representation of the world in order to understand the consequences of its actions [7, 8]. The main use cases are: pure representation learning, planning (look-ahead search), or learning a policy in the world model (neural simulator).

World modeling has been used as a pre-training task to learn a compact and general representation in a self-supervised way [82, 83]. Subsequently, using this representation as a state for traditional reinforcement learning (RL) algorithms significantly accelerated convergence speed. World models can also be utilized for look-ahead search, in order to plan by imagining the outcomes of future actions. They have proven to be highly effective in game environments or board games [9, 84]. Additionally, world models can be a solution to the sample efficiency issues of RL algorithms by acting as a simulator of the environment [7, 85, 86, 62, 13, 15, 87], although this assumes the world model is an accurate model of the environment.

A recent line of work suggests casting world modeling as a single sequence model, treating states, actions and rewards as simply a stream of data [10, 19, 14, 88, 12, 89]. The advantage of such a perspective is that world models can benefit from scaling properties of high-capacity sequence model architectures applied to large-scale unsupervised training [26]. This is the approach that GAIA-1 takes, leveraging those scaling properties to model complex environments such as real-world driving scenes.

Scaling. Large language models have shown clear benefits in scaling model size and data [90, 24, 26, 20, 21, 22, 23]. In particular, [49] showed predictable relationships between model/data size and loss over multiple orders of magnitude. [49] derived power laws for transformer based language models in order to optimally allocate the compute budget between the model and data size. Those laws were then refined by [27] by adapting the learning rate schedule when changing the dataset size. Another direction of research to improve the training efficiency of language models is data quality. [91] showed that the quality of the training data plays a critical role in the performance of language models in downstream tasks.

Transferring the scaling principles from large language models to the visual domain holds the potential for delivering consistent and expected performance improvements [92, 93, 43, 16, 94]. In this work, by casting the problem of world modeling as unsupervised sequence modeling, we have shown that similar scaling trends from language models also applied to world models.

### 9 Conclusions and Future Work

GAIA-1 is a generative world model for autonomous driving. The world model uses vector-quantized representations to turn the task of future prediction into a next token prediction task, a technique that has been successfully employed in large language models. GAIA-1 has demonstrated its capability to acquire a comprehensive understanding of the environment, distinguishing between various concepts such as cars, trucks, buses, pedestrians, cyclists, road layouts, buildings, and traffic lights—all through self-supervision. Further, GAIA-1 harnesses the capabilities of video diffusion models to generate realistic driving scenarios, thereby functioning as an advanced neural simulator. GAIA-1 is a multimodal approach that enables the control of the ego-vehicle's actions and other scene attributes through a combination of textual and action-based instructions.

While our method demonstrated promising results that have the potential to push the boundaries of autonomous driving, it is important to acknowledge current limitations. For instance, the autoregressive generation process, while highly effective, does not yet run at real-time. Nevertheless, it is noteworthy that this process lends itself well to parallelization, allowing for the concurrent generation of multiple samples.

The significance of GAIA-1 extends beyond its generative capabilities. World models represent a crucial step towards achieving autonomous systems that can understand, predict, and adapt to the complexities of the real world. Furthermore, by incorporating world models into driving models, we can enable them to better understand their own decisions and ultimately generalize to more real-world situations. Lastly, GAIA-1 can also serve as a valuable neural simulator, allowing the generation of unlimited data, including adversarial examples, for training and validating autonomous driving systems.

### II. Implicit Neural World State for Autonomous Driving

### 1. Pre-Training the World Model

In Chapter I above, it is disclosed how to learn a world model. For ease of reference, this world modelling process is summarised in brief below, where this process acts as a pre-training stage resulting in a pre-trained world model suitable for use in the driving model outlined later. This driving model builds upon the foundation provided by GAIA-1. The architecture used in the pre-training phase corresponds to the architecture described previously with reference to FIG. 2, though it will be appreciated that other configurations may be used with the principles of the invention.

The input modalities include an input video 100, driving actions 102, and text 104. Additional modalities may be included such as auxiliary sensor data (e.g. using data from sensors such as radar, lidar, infrared, ultrasonic sensors, or such like)—where such additional modalities are included, they would have the data received and encoded in a similar way, with the resultant encodings being temporally aligned with the encodings from the other modalities, with the corresponding sequence of tokens being modelled using the autoregressive transformer in the same way set out above.

The input video 100 comprises a sequence of time-ordered image frames. The driving actions 102 correspond to driving parameters, such as amounts of acceleration or braking being applied, a steering angle, a speed, an acceleration rate, a braking rate, a curvature rate, or such like. The driving actions 102 may be raw signals, or may be formatted in some suitable manner, e.g. provided in a vectorised form. The textual data provided may be a text-based description of a particular scenario. For example, textual training data may comprise text statements such as “I am approaching a crossing yielding to pedestrians” or “It is safe to move so I am now accelerating”.

It should be noted, however, that the training of the world model using modalities other than images (e.g. action and text) is optional. If driving is to be performed using image inputs only, then the world model need only have been trained using the video modality, however improved performance may be obtained by additionally training the world model using action and/or text modalities too. If an auxiliary sensor modality is used, it may be used both for pre-training the world model and during run-time, using the auxiliary sensors on the vehicle if present.

Where multiple modalities are used, each modality 100, 102, 104 is encoded separately using an appropriate encoder. An image encoder 106 encodes the frames of the input video 100 to generate image encodings 108. An action encoder 110 encodes the driving actions 102 to generate action encodings 112. A text encoder 114 encodes the text input 104 to generate text encodings 116.

The encodings 108, 112, 116 are aligned temporally, which allows the correct action 102 and/or text 104 to be aligned to the part of the video 100 it refers to. After this alignment, a sequence of input tokens 118 has been created that represent the inputs 100, 102, 104.

A world model 120 based on an autoregressive transformer is used to model this sequence (similar to LLMs known in the art perse such as GPT or Llama). During training, the weights of the world model 120 are learnt in the manner described hereinabove in Chapter I.

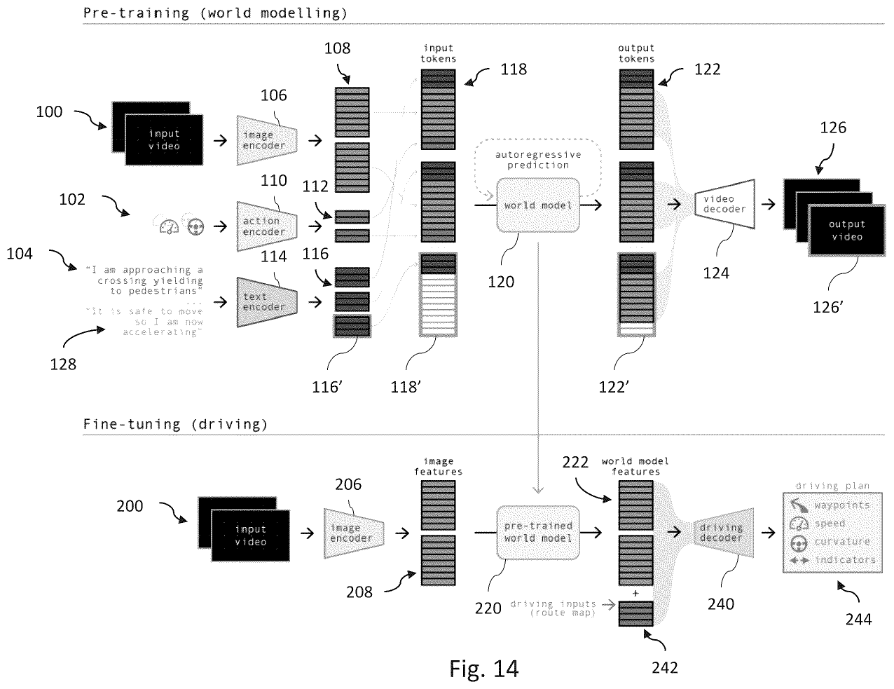

This world model 120 can predict one token at a time and generate output tokens 122 that correspond to the future frames. Given some past images (e.g. the two images shown in FIG. 14) in order to predict what happens in the next frame, the model can generate multiple output tokens 122.

The video decoder 124 can then decodes the tokens 122 back to a video 126, where that the image frames of that output video 126 have been synthetically generated based on the outputs of the world model 120.

As can be seen in FIG. 14, a text prompt 128 can be provided (without corresponding video or action inputs) in order to prompt the world model 120 to generate new video content 130. If so, only the corresponding text encodings 116′ are provided as input tokens 118′ to the world model 120, which then uses its learnings to generate output tokens 122′ which can be decoded by the video decoder 124 to generate the new output video 126′. For ease of reference, the inputs, tokens, and outputs involved in the process stemming from the input of this text prompt 128 are highlighted with a bold border in FIG. 14.

It should be noted that, for the purposes of generating a pre-trained world model suitable for use in autonomous driving (as explained below), the video decoder 124 is optional—there is no need to explicitly use the model for its generative video capabilities in order to drive, however this capability is mentioned here for completeness.

### 2. Driving Model Architecture

The resultant pre-trained world model is, in accordance with embodiments of the present invention, then used for the purposes of autonomous driving. The model is fine-tuned and trained for the task of driving. That driving model—which we call GAIA-Drive—can then be used to do inference in an autonomous vehicle.

As a result of the pre-training process set out above, the end result is five trained components—the image encoder 106, the action encoder 110, the text encoder 114, the world model 120, and the video decoder 124. For the purposes of the driving model, the components of interest are the trained image encoder 106 and world model 120.

The driving model comprises three components—an image encoder 206, a pre-trained world model 220, and a driving decoder 240. If an auxiliary sensor encoder were included during training of the world model, then that trained auxiliary sensor encoder may also be used for the driving model, however for ease of reference this is not shown in FIG. 14.

When training this driving model, the parameters of the world model 220 are initialised with the pre-trained weights as above, i.e. the weights of the world model 120.

Similarly, the parameters of the image encoder 206 are also initialised with the pre-trained weights learned when training the image encoder 106.

The parameters of the driving decoder 240 are initialised at random because this is a new component that was not present during the pre-training process.

For the driving model, we only encode videos 200 as we do not have text when running on a car but only inputs from the cameras. During the training process for this driving model, these videos 200 are pre-recorded videos for training, however at inference time the videos are taken from cameras on the vehicle in real time. As the image encodings do not need to be temporally aligned with any other modality (as images are the only input here), the image encodings 208 are used as the input tokens for the pre-trained world model 220.

The image features captured within the image encoding based input tokens 208 are processed using the world model 220 which produces output tokens relating to a world state 222 representative of the world modelling features. Critically, this world state 222 provides an implicit representation of the multiple possible futures that the world model 220 considers as a result of the image input 200 and its learnings from the earlier training phase. In other words, the output of the world model 220 is not itself a prediction of what will come next, but rather is a ‘fuzzy’ output representative of different possibilities based on sequences it has seen before, as applied to the new image input 200.

In addition to the world state 222 output by the world model 220, we can concatenate extra features that may be used for driving. In this particular example, we concatenate the world state 222 with driving input features 242 from the route map that is telling the model where to go (this may be a route and/or a destination, or similar).

The features of the world state 222 generated by the world model 220—together with the extra features 242 concatenated to these, if appropriate—are input to the driving decoder 240. The driving decoder 240 is configured to decode the inputs it is provided to a driving plan 244. The driving plan 244 may include one or more of: a waypoint, a speed, a velocity, a curvature, a trajectory, an indicator signal, an acceleration value, a braking value, a parking brake value, a steering angle, a lighting setting, and a horn setting.

The decoding process carried out by the driving decoder 240 is carried out in one forward pass. This avoids the autoregressive prediction (as used with the world model 120 during the pre-training phase)—by way of comparison, note the removal of the dashed line that looped back into the world model 120 in the pre-training phase.

As the world state 222 is used as the input to the driving decoder 240, rather than a prediction of a specific future generated by the world model 220, the driving decoder 240 receives information about multiple possible futures.

This means that the image encoding based input tokens 208 are processed into the world model features 222 by the pre-trained world model 220 without any autoregression, which means that the world model features 222—which provide an implicit representation of different possible futures—can be generated quickly. The driving decoder 240 can then be trained to take these ‘fuzzy’ inputs from the world model and predict a driving plan 244 based on that input.

### 3. Training the Driving Model

To train the driving model, a set of driving decoder weights for the driving decoder 240 are first initialised to a set of random values. As above, the weights for the image encoder 206 and world model 220 are imported from the pre-training process.

Video training data is supplied as the image input 200, where the video training data comprising a plurality of time-varying further image frames, as with videos described previously. As part of the training data, a driving plan prior corresponding to the video training data is provided—this driving plan prior is used to check performance of the driving model.

The image encoder 206 encodes the image frames from the video training data to generate image encodings, which as above are supplied as input tokens to the pre-trained world model 220. The pre-trained world model 220 generate a world state 222 from the image encodings.

The world state 222 (and potentially a training route plan) is input to the driving decoder 240 which generates a new driving plan 244 based on the world state 222 and the current set of driving decoder weights.

The new driving plan 244 is compared to the driving plan prior to determine a difference between these, and the set of driving decoder weights is updated based on that difference. Optionally, the set of weights for the world model may also be updated based on the difference.

This process may then be repeated with a further training videos and corresponding driving plan prior as many times as desired, incrementally updating the driving decoder weights (and potentially the world model weights).

Once the training of the driving model is complete, it is ready to be used for inference.

### 4. Inference

Once trained, the driving model can be used at inference time with new video image input 200 taken from camera(s) on the autonomous vehicle in the real-world environment.

The autonomous driving system can be provided driving input features 242, e.g. relating to a route map. This may, for example, be a desired route or an end destination (e.g. a user's house, office, a supermarket, or such like).

As the vehicle sets off driving, its cameras will capture images of its surroundings. These images are provided as the image input 200, which are processed by the driving model as above to generate the driving plan 244. The autonomous vehicle is then operated according to the driving plan.

### CONCLUSION

The proposed approach advantageously leverages information implicitly embedded within a world model (of the type usable to create synthetic driving videos) to drive a vehicle in a real world, practical environment with the constraints that environment imposes. This GAIA-Drive model builds on models such as GAIA-1 developed by the Applicant.

Whereas conventional approaches known in the art per se iteratively roll out a future scene and plan driving actions accordingly (and then repeat), embodiments of the present invention allow the driving plan to be formed in a single pass, providing for much faster processing. As speed is critical to the model being suitable for use in an autonomous vehicle, the approach provided by the present invention overcomes the issues associated with prior art approaches.

This data-driven approach allows the model can learn to estimate world states and predict their evolution from real-world data, which may provide more accurate modelling of complex real-world driving scenarios. The invention may provide improvements in adaptability and generalisation as the model can adapt to new scenarios and generalise to previously unseen situations, with the model being robust and better equipped to handle novel situations. Additionally, the model of the present invention may be subject to less bias because the model learns from data, reducing the need for manual design and minimising the potential for human-induced biases. This leads to more objective and unbiased training and validation data.

While specific embodiments of the present invention have been described in detail, it will be appreciated by those skilled in the art that the embodiments described in detail are not limiting on the scope of the claimed invention.

### REFERENCES

[1]A. Kendall, J. Hawke, D. Janz, P. Mazur, D. Reda, J.-M. Allen, V.-D. Lam, A. Bewley, and A. Shah. Learning to drive in a day. In Proceedings of the International Conference on Robotics and Automation (ICRA), 2019.
[2]H. Caesar, V. Bankiti, A. H. Lang, S. Vora, V. E. Liong, Q. Xu, A. Krishnan, Y. Pan, G. Baldan, and O. Beijbom. nuScenes: A multimodal dataset for autonomous driving. Proceedings of the IEEE Conference on Computer Vision and Pattern Recognition (CVPR), 2020.
[3]A. Hu, F. Cotter, N. Mohan, C. Gurau, and A. Kendall. Probabilistic Future Prediction for Video Scene Understanding. In Proceedings of the European Conference on Computer Vision (ECCV), 2020.
[4]S. Ettinger, S. Cheng, B. Caine, C. Liu, H. Zhao, S. Pradhan, Y. Chai, B. Sapp, C. Qi, Y. Zhou, Z. Yang, A. Chouard, P. Sun, J. Ngiam, V. Vasudevan, A. McCauley, J. Shlens, and D. Anguelov. Large Scale Interactive Motion Forecasting for Autonomous Driving: The Waymo Open Motion Dataset. In Proceedings of the IEEE International Conference on Computer Vision (ICCV), 2021.
[5]A. Hu, Z. Murez, N. Mohan, S. Dudas, J. Hawke, V. Badrinarayanan, R. Cipolla, and A. Kendall. FIERY: Future Instance Prediction in Bird's-Eye View From Surround Monocular Cameras. In Proceedings of the IEEE International Conference on Computer Vision (ICCV), pages 15273-15282, 2021.
[6]Y. Hu, J. Yang, L. Chen, K. Li, C. Sima, X. Zhu, S. Chai, S. Du, T. Lin, W. Wang, L. Lu, X. Jia, Q. Liu, J. Dai, Y. Qiao, and H. Li. Planning-oriented autonomous driving. In Proceedings of the IEEE Conference on Computer Vision and Pattern Recognition (CVPR), 2023.
[7]D. Ha and J. Schmidhuber. Recurrent world models facilitate policy evolution. In Advances in Neural Information Processing Systems (NeurIPS), 2018.
[8]Y. LeCun. A Path Towards Autonomous Machine Intelligence. In arXiv preprint, 2022.
[9]J. Schrittwieser, I. Antonoglou, T. Hubert, K. Simonyan, L. Sifre, S. Schmitt, A. Guez, E. Lockhart, D. Hassabis, T. Graepel, T. Lillicrap, and D. Silver. Mastering Atari, Go, Chess and Shogi by Planning with a Learned Model. In Nature, 2020.
[10]M. Janner, Q. Li, and S. Levine. Offline reinforcement learning as one big sequence modelling problem. In Advances in Neural Information Processing Systems (NeurIPS), 2021.
[11]A. Hu, G. Corrado, N. Griffiths, Z. Murez, C. Gurau, H. Yeo, A. Kendall, R. Cipolla, and J. Shotton. Model-Based Imitation Learning for Urban Driving. In Advances in Neural Information Processing Systems (NeurIPS), 2022.
[12]V. Micheli, E. Alonso, and F. Fleuret. Transformers are sample-efficient world models. In Proceedings of the International Conference on Learning Representations (ICLR), 2023.
[13]D. Hafner, J. Pasukonis, J. Ba, and T. Lillicrap. Mastering diverse domains through world models. In arXiv preprint, 2023.
[14]S. Reed, K. Zolna, E. Parisotto, S. Gomez, A. Novikov, G. Barth-Maron, M. Gimenez, Y. Sulsky, J. Kay, J. Springenberg, T. Eccles, J. Bruce, A. Razavi, A. Edwards, N. Heess, Y. Chen, R. Hadsell, O. Vinyals, M. Bordbar, and N. Freitas. A generalist agent. In Transactions on Machine Learning Research (TMLR), 2022.
[15]P. Wu, A. Escontrela, D. Hafner, P. Abbeel, and K. Goldberg. Daydreamer: World models for physical robot learning. In Proceedings of the Conference on Robot Learning (CoRL), 2023.
[16]J. Ho, W. Chan, C. Saharia, J. Whang, R. Gao, A. Gritsenko, D. P. Kingma, B. Poole, M. Norouzi, D. J. Fleet, and T. Salimans. Imagen video: High definition video generation with diffusion models. In arXiv preprint, 2022.
[17]W. Harvey, S. Naderiparizi, V. Masrani, C. Weilbach, and F. Wood. Flexible diffusion modelling of long videos. In Advances in Neural Information Processing Systems (NeurIPS), 2022.
[18]P. Esser, J. Chiu, P. Atighehchian, J. Granskog, and A. Germanidis. Structure and content-guided video synthesis with diffusion models. In arXiv preprint, 2023.
[19]L. Chen, K. Lu, A. Rajeswaran, K. Lee, A. Grover, M. Laskin, P. Abbeel, A. Srinivas, and I. Mordatch. Decision transformer: Reinforcement learning via sequence modeling. In Advances in Neural Information Processing Systems (NeurIPS), 2021.
[20]S. Smith, M. M. A. Patwary, B. Norick, P. Legresley, S. Rajbhandari, J. Casper, Z. Liu, S. Prabhumoye, G. Zerveas, V. Korthikanti, E. Zhang, R. Child, R. Aminabadi, J. Bernauer, X. Song, M. Shoeybi, Y. He, M. Houston, S. Tiwary, and B. Catanzaro. Using DeepSpeed and Megatron to Train Megatron-Turing NLG 530B, A Large-Scale Generative Language Model. In arXiv preprint, 2022.
[21]A. Chowdhery, S. Narang, J. Devlin, M. Bosma, G. Mishra, A. Roberts, P. Barham, H. W. Chung, C. Sutton, S. Gehrmann, P. Schuh, K. Shi, S. Tsvyashchenko, J. Maynez, A. Rao, P. Barnes, Y. Tay, N. M. Shazeer, V. Prabhakaran, E. Reif, N. Du, B. C. Hutchinson, R. Pope, J. Bradbury, J. Austin, M. Isard, G. Gur-Ari, P. Yin, T. Duke, A. Levskaya, S. Ghemawat, S. Dev, H. Michalewski, X. Garcia, V. Misra, K. Robinson, L. Fedus, D. Zhou, D. Ippolito, D. Luan, H. Lim, B. Zoph, A. Spiridonov, R. Sepassi, D. Dohan, S. Agrawal, M. Omernick, A. M. Dai, T. S. Pillai, M. Pellat, A. Lewkowycz, E. Moreira, R. Child, O. Polozov, K. Lee, Z. Zhou, X. Wang, B. Saeta, M. Diaz, O. Firat, M. Catasta, J. Wei, K. S. Meier-Hellstern, D. Eck, J. Dean, S. Petrov, and N. Fiedel. PaLM: Scaling language modeling with pathways. arXiv preprint, 2022.
[22]H. Touvron, T. Lavril, G. Izacard, X. Martinet, M.-A. Lachaux, T. Lacroix, B. Roziere, N. Goyal, E. Hambro, F. Azhar, A. Rodriguez, A. Joulin, E. Grave, and G. Lample. Llama: Open and efficient foundation language models. In arXiv preprint, 2023.
[23] OpenAI. GPT-4 Technical Report. In arXiv preprint, 2023.
[24]C. Raffel, N. Shazeer, A. Roberts, K. Lee, S. Narang, M. Matena, Y. Zhou, W. Li, and P. J. Liu. Exploring the limits of transfer learning with a unified text-to-text transformer. Journal of Machine Learning Research, 2020.
[25]Y. Liu, M. Ott, N. Goyal, J. Du, M. Joshi, D. Chen, O. Levy, M. Lewis, L. Zettlemoyer, and V. Stoyanov. Roberta: A robustly optimized bert pretraining approach. arXiv preprint, 2019.
[26]T. Brown, B. Mann, N. Ryder, M. Subbiah, J. D. Kaplan, P. Dhariwal, A. Neelakantan, P. Shyam, G. Sastry, A. Askell, S. Agarwal, A. Herbert-Voss, G. Krueger, T. Henighan, R. Child, A. Ramesh, D. Ziegler, J. Wu, C. Winter, C. Hesse, M. Chen, E. Sigler, M. Litwin, S. Gray, B. Chess, J. Clark, C. Berner, S. McCandlish, A. Radford, I. Sutskever, and D. Amodei. Language Models are Few-Shot Learners. In Advances in Neural Information Processing Systems (NeurIPS), 2020.
[27]J. Hoffmann, S. Borgeaud, A. Mensch, E. Buchatskaya, T. Cai, E. Rutherford, D. de las Casas, L. A. Hendricks, J. Welbl, A. Clark, T. Hennigan, E. Noland, K. Millican, G. van den Driessche, B. Damoc, A. Guy, S. Osindero, K. Simonyan, E. Elsen, O. Vinyals, J. W. Rae, and L. Sifre. An empirical analysis of compute-optimal large language model training. In Advances in Neural Information Processing Systems (NeurIPS), 2022.
[28]A. van den Oord, O. Vinyals, and K. Kavukcuoglu. Neural discrete representation learning. In Advances in Neural Information Processing Systems (NeurIPS), 2017.
[29]Z. Peng, L. Dong, H. Bao, Q. Ye, and F. Wei. BEiT v2: Masked Image Modeling with Vector-Quantized Visual Tokenizers. arXiv preprint, 2022.
[30]M. Caron, H. Touvron, I. Misra, H. Jegou, J. Mairal, P. Bojanowski, and A. Joulin. Emerging properties in self-supervised vision transformers. In Proceedings of the IEEE International Conference on Computer Vision (ICCV), 2021.
[31] O. Ronneberger, P. Fischer, and T. Brox. U-Net: Convolutional Networks for Biomedical Image Segmentation. In Medical Image Computing and Computer-Assisted Intervention (MICCAI), 2015.
[32]J. Johnson, A. Alahi, and L. Fei-Fei. Perceptual losses for real-time style transfer and superresolution. In Proceedings of the European Conference on Computer Vision (ECCV), 2016.
[33]P. Esser, R. Rombach, and B. Ommer. Taming transformers for high-resolution image synthesis. In Proceedings of the IEEE Conference on Computer Vision and Pattern Recognition (CVPR), 2021.
[34]J. Yu, X. Li, J. Y. Koh, H. Zhang, R. Pang, J. Qin, A. Ku, Y. Xu, J. Baldridge, and Y. Wu. Vector-quantized image modeling with improved VQGAN. In Proceedings of the International Conference on Learning Representations (ICLR), 2022.
[35]A. Vaswani, N. Shazeer, N. Parmar, J. Uszkoreit, L. Jones, A. Gomez, L. Kaiser, and I. Polosukhin. Attention is all you need. In Advances in Neural Information Processing Systems (NeurIPS), 2017.
[36]R. Rombach, A. Blattmann, D. Lorenz, P. Esser, and B. Ommer. High-resolution image synthesis with latent diffusion models. In Proceedings of the IEEE Conference on Computer Vision and Pattern Recognition (CVPR), 2022.
[37]C. Saharia, W. Chan, S. Saxena, L. Li, J. Whang, E. Denton, S. K. S. Ghasemipour, B. K. Ayan, S. S. Mahdavi, R. G. Lopes, T. Salimans, J. Ho, D. J. Fleet, and M. Norouzi. Photorealistic text-to-image diffusion models with deep language understanding. In Advances in Neural Information Processing Systems (NeurIPS), 2022.
[38]J. Ho, T. Salimans, A. Gritsenko, W. Chan, M. Norouzi, and D. J. Fleet. Video diffusion models.

In arXiv preprint, 2022.
[39]J. H. Tim Salimans. Progressive distillation for fast sampling of diffusion models. In Proceedings of the International Conference on Learning Representations (ICLR), 2022.
[40]I. Loshchilov and F. Hutter. Decoupled Weight Decay Regularization. In Proceedings of the International Conference on Learning Representations (ICLR), 2019.
[41]T. Dao, D. Y. Fu, S. Ermon, A. Rudra, and C. Re. FlashAttention: Fast and memory-efficient exact attention with IO-awareness. In Advances in Neural Information Processing Systems (NeurIPS), 2022.
[42]J. Rasley, S. Rajbhandari, O. Ruwase, and Y. He. DeepSpeed: System Optimizations Enable Training Deep Learning Models with Over 100 Billion Parameters. In Proceedings of the 2^{6th} ACM SIGKDD International Conference on Knowledge Discovery & Data Mining, 2020.
[43]E. Hoogeboom, J. Heek, and T. Salimans. simple diffusion: End-to-end diffusion for high resolution images. In Proceedings of the International Conference on Machine Learning (ICML), 2023.
[44]A. Holtzman, J. Buys, L. Du, M. Forbes, and Y. Choi. The curious case of neural text degeneration. In Proceedings of the International Conference on Learning Representations (ICLR), 2020.
[45]J. Ho and T. Salimans. Classifier-free diffusion guidance. arXiv preprint, 2022.
[46]H. Chang, H. Zhang, J. Barber, A. Maschinot, J. Lezama, L. Jiang, M.-H. Yang, K. Murphy, W. T. Freeman, M. Rubinstein, et al. Muse: Text-to-image generation via masked generative transformers. arXiv preprint, 2023.
[47] Negative prompt. https://github.com/AUTOMATIC1111/stable-diffusion-webui/wiki/Negative-prompt, 2022.
[48]J. Song, C. Meng, and S. Ermon. Denoising diffusion implicit models. Proceedings of the International Conference on Learning Representations (ICLR), 2021.
[49]J. Kaplan, S. McCandlish, T. Henighan, T. B. Brown, B. Chess, R. Child, S. Gray, A. Radford, J. Wu, and D. Amodei. Scaling laws for neural language models. In arXiv preprint, 2020.
[50]D. P. Kingma and M. Welling. Auto-encoding variational bayes. Proceedings of the International Conference on Learning Representations (ICLR), 2014.
[51]I. Goodfellow, J. Pouget-Abadie, M. Mirza, B. Xu, D. Warde-Farley, S. Ozair, A. Courville, and Y. Bengio. Generative adversarial nets. In Advances in Neural Information Processing Systems (NeurIPS), 2014.
[52]J. Sohl-Dickstein, E. Weiss, N. Maheswaranathan, and S. Ganguli. Deep unsupervised learning using nonequilibrium thermodynamics. In Proceedings of the International Conference on Machine Learning (ICML), 2015.
[53]A. van den Oord, N. Kalchbrenner, L. Espeholt, k. kavukcuoglu, O. Vinyals, and A. Graves. Conditional image generation with pixelcnn decoders. In Advances in Neural Information Processing Systems (NeurIPS), 2016.
[54]M. Babaeizadeh, C. Finn, D. Erhan, R. H. Campbell, and S. Levine. Stochastic variational video prediction. In Proceedings of the International Conference on Learning Representations (ICLR), 2018.
[55]E. Denton and R. Fergus. Stochastic Video Generation with a Learned Prior. In Proceedings of the International Conference on Machine Learning (ICML), 2018.
[56]R. Villegas, A. Pathak, H. Kannan, D. Erhan, Q. Le, and H. Lee. High fidelity video prediction with large stochastic recurrent neural networks. In Advances in Neural Information Processing Systems (NeurIPS), 2019.
[57]J.-Y. Franceschi, E. Delasalles, M. Chen, S. Lamprier, and P. Gallinari. Stochastic latent residual video prediction. In Proceedings of the International Conference on Machine Learning (ICML), 2020.
[58]M. Babaeizadeh, M. Saffar, S. Nair, S. Levine, C. Finn, and D. Erhan. Fitvid: Overfitting in pixel-level video prediction. In arXiv preprint, 2021.
[59]C. Vondrick, H. Pirsiavash, and A. Torralba. Generating videos with scene dynamics. In Advances in Neural Information Processing Systems (NeurIPS), 2016.
[60]S. Tulyakov, M.-Y. Liu, X. Yang, and J. Kautz. MoCoGAN: Decomposing motion and content for video generation. In Proceedings of the IEEE Conference on Computer Vision and Pattern Recognition (CVPR), 2018.
[61]A. Clark, J. Donahue, and K. Simonyan. Adversarial Video Generation on Complex Datasets. In arXiv preprint, 2019.
[62]S. W. Kim, J. Philion, A. Torralba, and S. Fidler. DriveGAN: Towards a controllable high-quality neural simulation. In Proceedings of the IEEE Conference on Computer Vision and Pattern Recognition (CVPR), 2021.
[63] I. Skorokhodov, S. Tulyakov, and M. Elhoseiny. StyleGAN-V: A continuous video generator with the price, image quality and perks of StyleGAN2. In Proceedings of the IEEE Conference on Computer Vision and Pattern Recognition (CVPR), 2022.
[64]T. Brooks, J. Hellsten, M. Aittala, T.-C. Wang, T. Aila, J. Lehtinen, M.-Y. Liu, A. Efros, and T. Karras. Generating long videos of dynamic scenes. In Advances in Neural Information Processing Systems (NeurIPS), 2022.
[65] I. Goodfellow. NIPS 2016 Tutorial: Generative Adversarial Networks. In arXiv preprint, 2016.
[66] V. Voleti, A. Jolicoeur-Martineau, and C. Pal. MCVD: Masked conditional video diffusion for prediction, generation, and interpolation. In Advances in Neural Information Processing Systems (NeurIPS), 2022.
[67]T. Hoppe, A. Mehrjou, S. Bauer, D. Nielsen, and A. Dittadi. Diffusion models for video prediction and infilling. In Transactions on Machine Learning Research (TMLR), 2022.
[68] U. Singer, A. Polyak, T. Hayes, X. Yin, J. An, S. Zhang, Q. Hu, H. Yang, O. Ashual, O. Gafni, D. Parikh, S. Gupta, and Y. Taigman. Make-A-Video: Text-to-video generation without textvideo data. In arXiv preprint, 2022.
[69] E. Molad, E. Horwitz, D. Valevski, A. R. Acha, Y. Matias, Y. Pritch, Y. Leviathan, and Y. Hoshen. Dreamix: Video diffusion models are general video editors. arXiv preprint, 2023. [70] D. Zhou, W. Wang, H. Yan, W. Lv, Y. Zhu, and J. Feng. Magicvideo: Efficient video generation with latent diffusion models. arXiv preprint, 2022.
[71]A. Blattmann, R. Rombach, H. Ling, T. Dockhorn, S. W. Kim, S. Fidler, and K. Kreis. Align your latents: High-resolution video synthesis with latent diffusion models. In Proceedings of the IEEE Conference on Computer Vision and Pattern Recognition (CVPR), 2023.
[72]N. Kalchbrenner, A. van den Oord, K. Simonyan, I. Danihelka, O. Vinyals, A. Graves, and K. Kavukcuoglu. Video Pixel Networks. In Proceedings of the International Conference on Machine Learning (ICML), 2017.
[73]D. Weissenborn, O. Tackstrom, and J. Uszkoreit. Scaling autoregressive video models. Proceedings of the International Conference on Learning Representations (ICLR), 2020.
[74]W. Yan, Y. Zhang, P. Abbeel, and A. Srinivas. VideoGPT: Video generation using vq-vae and transformers. In arXiv preprint, 2021.
[75]G. L. Moing, J. Ponce, and C. Schmid. CCVS: Context-aware controllable video synthesis. In Advances in Neural Information Processing Systems (NeurIPS), 2021.
[76]S. Ge, T. Hayes, H. Yang, X. Yin, G. Pang, D. Jacobs, J.-B. Huang, and D. Parikh. Long video generation with time-agnostic vqgan and time-sensitive transformer. Proceedings of the European Conference on Computer Vision (ECCV), 2022.
[77]Y. Seo, K. Lee, F. Liu, S. James, and P. Abbeel. HARP: Autoregressive latent video prediction with high-fidelity image generator. In Proceedings of the IEEE International Conference on Image Processing (ICIP), 2022.
[78]W. Yan, D. Hafner, S. James, and P. Abbeel. Temporally consistent transformers for video generation. In Proceedings of the International Conference on Machine Learning (ICML), 2023.
[79]R. Villegas, M. Babaeizadeh, P.-J. Kindermans, H. Moraldo, H. Zhang, M. T. Saffar, S. Castro, J. Kunze, and D. Erhan. Phenaki: Variable length video generation from open domain textual description. In Proceedings of the International Conference on Learning Representations (ICLR), 2023.
[80]L. Yu, Y. Cheng, K. Sohn, J. Lezama, H. Zhang, H. Chang, A. G. Hauptmann, M.-H. Yang, Y. Hao, I. Essa, and L. Jiang. MAGVIT: Masked Generative Video Transformer. In Proceedings of the IEEE Conference on Computer Vision and Pattern Recognition (CVPR), 2023.
[81]C. Hawthorne, A. Jaegle, C. Cangea, S. Borgeaud, C. Nash, M. Malinowski, S. Dieleman, O. Vinyals, M. Botvinick, I. Simon, H. Sheahan, N. Zeghidour, J.-B. Alayrac, J. Carreira, and J. Engel. General-purpose, long-context autoregressive modeling with Perceiver AR. In Proceedings of the International Conference on Machine Learning (ICML), 2022
[82]M. Schwarzer, A. Anand, R. Goel, R. D. Hjelm, A. C. Courville, and P. Bachman. Data-efficient reinforcement learning with self-predictive representations. In Proceedings of the International Conference on Learning Representations (ICLR), 2020.
[83]P. Wu, A. Majumdar, K. Stone, Y. Lin, I. Mordatch, P. Abbeel, and A. Rajeswaran. Masked trajectory models for prediction, representation, and control. In Proceedings of the International Conference on Machine Learning (ICML), 2023.
[84]W. Ye, S. Liu, T. Kurutach, P. Abbeel, and Y. Gao. Mastering atari games with limited data. In Advances in Neural Information Processing Systems (NeurIPS), 2021.
[85]L. Kaiser, M. Babaeizadeh, P. Milos, B. Osinski, R. Campbell, K. Czechowski, D. Erhan, C. Finn, P. Kozakowski, S. Levine, A. Mohiuddin, R. Sepassi, G. Tucker, and H. Michalewski. Model-based reinforcement learning for atari. In Proceedings of the International Conference on Learning Representations (ICLR), 2020.
[86]D. Hafner, T. Lillicrap, M. Norouzi, and J. Ba. Mastering atari with discrete world models. Proceedings of the International Conference on Learning Representations (ICLR), 2021.
[87]X. Wang, Z. Zhu, G. Huang, X. Chen, and J. Lu. DriveDreamer: Towards Real-world-driven World Models for Autonomous Driving. arXiv preprint, 2023.
[88]F. Liu, H. Liu, A. Grover, and P. Abbeel. Masked autoencoding for scalable and generalizable decision making. Advances in Neural Information Processing Systems (NeurIPS), 2022.
[89] commaVQ. https://github.com/commaai/commavq, 2023.
[90]J. Devlin, M.-W. Chang, K. Lee, and K. Toutanova. BERT: Pre-training of Deep Bidirectional Transformers for Language Understanding. North American Chapter of the Association for Computational Linguistics (NAACL), 2019.
[91]N. Du, Y. Huang, A. M. Dai, S. Tong, D. Lepikhin, Y. Xu, M. Krikun, Y. Zhou, A. W. Yu, O. Firat, B. Zoph, L. Fedus, M. Bosma, Z. Zhou, T. Wang, Y. E. Wang, K. Webster, M. Pellat, K. Robinson, K. S. Meier-Hellstern, T. Duke, L. Dixon, K. Zhang, Q. V. Le, Y. Wu, Z. Chen, and C. Cui. GLaM: Efficient scaling of language models with mixture-of-experts. In Proceedings of the International Conference on Machine Learning (ICML), 2022.
[92]Y. Tay, M. Dehghani, J. Rao, W. Fedus, S. Abnar, H. W. Chung, S. Narang, D. Yogatama, A. Vaswani, and D. Metzler. Scale efficiently: Insights from pre-training and fine-tuning transformers. In Proceedings of the International Conference on Learning Representations (ICLR), 2022.
[93]M. Dehghani, J. Djolonga, B. Mustafa, P. Padlewski, J. Heek, J. Gilmer, A. Steiner, M. Caron, R. Geirhos, I. Alabdulmohsin, R. Jenatton, L. Beyer, M. Tschannen, A. Arnab, X. Wang, C. Riquelme, M. Minderer, J. Puigcerver, U. Evci, M. Kumar, S. van Steenkiste, G. F. Elsayed, A. Mahendran, F. Yu, A. Oliver, F. Huot, J. Bastings, M. P. Collier, A. Gritsenko, V. Birodkar, C. Vasconcelos, Y. Tay, T. Mensink, A. Kolesnikov, F. Paveti\acute{ }c, D. Tran, T. Kipf, M. Lu ̌ci\acute{ }c, X. Zhai, D. Keysers, J. Harmsen, and N. Houlsby. Scaling vision transformers to 22 billion parameters. In Proceedings of the International Conference on Machine Learning (ICML), 2023.
[94]W. Peebles and S. Xie. Scalable diffusion models with transformers. In arXiv preprint, 2023.
[95] https://www.youtube.com/playlist?list=PL5ksjZd5b6SI-6MQi6ghoD-GilTPmsQif

1. An autonomous driving system comprising:
an image encoder configured to receive video input data, said video input data comprising a plurality of time-varying image frames, wherein the image encoder is further configured to encode the image frames as a sequence of input tokens;
a pre-trained world model having a set of pre-trained world model weights, the world model being configured to receive the sequence of input tokens and to generate therefrom a world state based on said sequence, wherein the world state comprises an implicit representation of candidate future events; and
a driving decoder configured to receive the world state from the world model and to generate in a single forward pass a driving plan based on the implicit representation of candidate future events.

2. The autonomous driving system as claimed in claim 1, wherein the driving plan comprises one or more of: a waypoint, a speed, a velocity, a curvature, a trajectory, an indicator signal, an acceleration value, a braking value, a parking brake value, a steering angle, a lighting setting, and a horn setting.

3. The autonomous driving system as claimed in claim 1, wherein the driving decoder is further configured to receive a route plan input, wherein the driving decoder is further configured to generate the driving plan based on the route plan input.

4. (canceled)

5. The autonomous driving system as claimed in claim 1, wherein the pre-trained world model is trained by:
i) receiving video training data, said video training data comprising a plurality of time-varying image frames;
ii) encoding the image frames to generate image encodings;
iii) generating a sequence of input tokens from the image encodings; and
iv) using an autoregressive transformer to model the sequence of input tokens, thereby generating the pre-trained world model and the set of pre-trained world model weights.

6. The autonomous driving system as claimed in claim 1, wherein the driving decoder is trained by:
i) initialising a set of driving decoder weights;
ii) receiving further video training data, said further video training data comprising a plurality of time-varying further image frames;
iii) encoding the further image frames to generate further image encodings;
iv) generating a sequence of further input tokens from the further image encodings;
v) inputting the further image encodings to the trained world model, and using the trained world model to generate a world state from said further image encodings;
vi) inputting the world state to the driving decoder, and using the driving decoder to generate a new driving plan based on the world state and a current set of driving decoder weights; and
vii) updating the set of driving decoder weights based on a difference between the new driving plan and a driving plan prior corresponding to the further video training data.

7. The autonomous driving system as claimed in claim 6, wherein training the driving decoder further comprises receiving a training route plan input corresponding to the further video training data, wherein the driving decoder is further configured to generate the new driving plan based on the training route plan input.

8. The autonomous driving system as claimed in claim 6, configured to update the set of world model weights based on the difference between the new driving plan and the driving plan prior corresponding to the further video training data.

9. The autonomous driving system as claimed in claim 1, further comprising one or more cameras configured to capture the video input data and to provide said video input data to the image encoder.

10. A method of operating an autonomous driving system, the method comprising:
i) receiving video input data, said video input data comprising a plurality of time-varying image frames;
ii) encoding the image frames as a sequence of input tokens;
iii) inputting the sequence of input tokens into a pre-trained world model having a set of pre-trained world model weights;
iv) using the pre-trained world model to generate a world state based on said sequence, wherein the world state comprises an implicit representation of candidate future events; and
v) in a single forward pass, generating from the world state a driving plan based on the implicit representation of candidate future events.

11.-16. (canceled)

17. A method of training an autonomous driving system, the method comprising:
a) training a world model to generate a world state from video input data, wherein the world state comprises an implicit representation of candidate future events, the step of training the world model comprising:
i) receiving video training data, said video training data comprising a plurality of time-varying image frames;
ii) encoding the image frames to generate image encodings;
iii) generating a sequence of input tokens from the image encodings; and
iv) using an autoregressive transformer to model the sequence, thereby generating a trained world model having a set of learned world model weights; and
b) training a machine learning driving decoder to generate driving plans based on world states received from the world model, the step of training the driving decoder comprising:
i) initialising a set of driving decoder weights;
ii) receiving further video training data, said further video training data comprising a plurality of time-varying further image frames;
iii) encoding the further image frames to generate further image encodings;
iv) generating a sequence of further input tokens from the further image encodings;
v) inputting the further image encodings to the trained world model, and using the trained world model to generate a world state from said further image encodings;
vi) inputting the world state to the driving decoder, and using the driving decoder to generate a new driving plan based on the world state and a current set of driving decoder weights; and
vii) updating the set of driving decoder weights based on a difference between the new driving plan and a driving plan prior corresponding to the further video training data.

18. The method as claimed in claim 17, wherein a trainable image encoder is used for encoding the image frames to generate the image encodings, wherein the method comprises training a set of image encoder weights of the image encoder.

19. The method as claimed in claim 18, wherein the trained set of image encoder weights of the image encoder are used for encoding the further image frames to generate further image encodings.

20. The method as claimed in claim 17, wherein the step of training the world model further comprises:
i) receiving action training data, said action training data comprising a plurality of time-varying driving actions;
ii) encoding the driving actions to generate action encodings;
iii) temporally aligning the image encodings and action encodings; and
iv) generating the sequence of input tokens from the temporally aligned image encodings and action encodings.

21. The method as claimed in claim 20, wherein a trainable action encoder is used for encoding the driving actions to generate the action encodings, wherein the method comprises training a set of action encoder weights of the action encoder.

22. The method as claimed in claim 17, wherein the step of training the world model further comprises:
i) receiving textual training data, said textual training data comprising a plurality of time-varying text data;
ii) encoding the text data to generate text encodings;
iii) temporally aligning the image encodings and text encodings; and
iv) generating the sequence of input tokens from the temporally aligned image encodings and text encodings.

23. The method as claimed in claim 22, wherein a trainable text encoder is used for encoding the text data to generate the text encodings, wherein the method comprises training a set of text encoder weights of the text encoder.

24. The method as claimed in claim 17, wherein the step of training the world model further comprises:
i) receiving auxiliary sensor training data, said auxiliary sensor training data comprising a plurality of time-varying data relating to measurements from one or more auxiliary sensors;
ii) encoding the auxiliary sensor data to generate auxiliary sensor encodings;
iii) temporally aligning the image encodings and auxiliary sensor encodings; and
iv) generating the sequence of input tokens from the temporally aligned image encodings and auxiliary sensor encodings.

25. The method as claimed in claim 24, wherein a trainable auxiliary sensor encoder is used for encoding the auxiliary sensor data to generate the auxiliary sensor encodings, wherein the method comprises training a set of auxiliary sensor encoder weights of the auxiliary sensor encoder.

26. (canceled)

27. The method as claimed in claim 15, further comprising updating the set of world model weights based on the difference between the new driving plan and the driving plan prior corresponding to the further video training data.

28. A method of training a machine learning driving decoder, the method comprising:
i) receiving a pre-trained world model having a set of learned world model weights;
ii) initialising a set of driving decoder weights;
iii) receiving video training data, said video training data comprising a plurality of time-varying further image frames;
iv) encoding the image frames to generate image encodings;
v) generating a sequence of input tokens from the image encodings;
vi) inputting the image encodings to the pre-trained world model, and using the pre-trained world model to generate a world state from said image encodings;
vi) inputting the world state to the driving decoder, and using the driving decoder to generate a new driving plan based on the world state and a current set of driving decoder weights; and
vii) updating the set of driving decoder weights based on a difference between the new driving plan and a driving plan prior corresponding to the video training data.

29.-30. (canceled)

31. A method of training an autonomous driving system, the method comprising:
a) training a world model to generate a world state from video input data, wherein the world state comprises an implicit representation of candidate future events, the step of training the world model comprising:
i) receiving video training data, said video training data comprising a plurality of time-varying image frames;
ii) encoding the image frames to generate image encodings;
iii) generating a sequence of input tokens from the image encodings; and
iv) using an autoregressive transformer to model the sequence, thereby generating a trained world model having a set of learned world model weights.

32. A non-transitory computer-readable medium comprising instructions which, when executed by a processor, cause the processor to carry out the method of claim 10.

33. (canceled)

34. A world model for use in an autonomous driving system, said world model having a set of pre-trained world model weights, wherein the world model is configured to:
i) receive a sequence of input tokens comprising image encodings; and
ii) generate a world state based on said sequence, wherein the world state comprises an implicit representation of candidate future events.

35. A non-transitory computer-readable medium comprising instructions which, when executed by a processor, cause the processor to carry out the method of claim 17.

36. A non-transitory computer-readable medium comprising instructions which, when executed by a processor, cause the processor to carry out the method of claim 28.

37. A non-transitory computer-readable medium comprising instructions which, when executed by a processor, cause the processor to carry out the method of claim 31.
